(19) United States
(12) Patent Application Publication
(10) Pub. No.: US 2014/0116268 A1
(43) Pub. Date: May 1, 2014

(54) OVEN FOR HEATING FOOD

(71) Applicant: Duke Manufacturing Co.,, St. Louis, MO (US)

(72) Inventors: James W. Bigott, Fenton, MO (US); Steven M. Shei, Fort Wayne, IN (US); Rafael K. Thissen, Chesterfield, MO (US); Robert J. Reese, Edwardsville, IL (US)

(73) Assignee: Duke Manufacturing Co.,, St. Louis (MO)

(21) Appl. No.: 14/068,168

(22) Filed: Oct. 31, 2013

Related U.S. Application Data
(60) Provisional application No. 61/720,677, filed on Oct. 31, 2012.

(51) Int. Cl. A47J 39/00

(52) U.S. Cl. CPC A47J 39/003
USPC 99/483

(57) ABSTRACT

An oven for heating food is disclosed. The oven has at least one heating compartment including an open front or an open top in open communication with a surrounding environment outside the oven. A food support may be provided for supporting food in the heating compartment. Gas flow openings may be provided for introducing heated gas into the heating compartment for heating the food. The gas may be heated by a heater system and blown through the gas flow openings by a blower system. Gas may be exhausted from the heating compartment via gas flow openings in the heating compartment. The oven may include oven modules.

### FIELD OF THE INVENTION

The present invention generally relates to food serving equipment, and more particularly to an oven for heating food.

### BACKGROUND OF THE INVENTION

In one embodiment, this invention is directed to an oven which uses hot gas to maintain pre-cooked food at proper temperatures before serving. This type of equipment is often referred to using such terms as a holding oven, or a holding unit, or a food warmer. Such equipment is used in the fast food service industry to heat food prior to serving it.

### SUMMARY

One aspect of the present invention is directed to an oven for heating food including a first heating compartment having first and second opposing side walls, a first food support surface for supporting food to be heated, and an open top in open communication with a surrounding environment outside the oven. First gas flow openings are provided in the first and second opposing side walls. A first blower system blows gas through the first gas flow openings into the first heating compartment for flow onto the food supported by the first food support surface. A first heater system heats gas blowing into the heating compartment through the first gas flow openings.

Another aspect of the present invention is directed to an oven for heating food including a first heating compartment for heating food placed in the compartment. The heating compartment has at least one side wall, a bottom wall, and an open top in open communication with a surrounding environment outside the oven. First gas flow openings are provided in the at least one side wall. A first blower system blows gas through the gas flow openings in the at least one side wall into the first heating compartment. A first heater system heats gas blowing into the first heating compartment through the gas flow openings in the at least one side wall. First gas flow openings are provided in the bottom wall of the heating compartment. Gas blows into the first heating compartment via the first gas flow openings in the at least one side wall and gas exhausts from the first heating compartment via the first gas flow openings in the bottom wall of the first heating compartment.

Yet another aspect of the present invention is directed to an oven for heating food including a first heating compartment having at least a first side wall and a food support surface for supporting food to be heated. First gas flow openings are provided in the first side wall. A first blower system blows gas through the first gas flow openings into the first heating compartment for flow onto the food supported by the first food support surface. A first heater system heats gas blowing into the heating compartment through the first gas flow openings. A motion sensor is provided for detecting motion within the first heating compartment. A control responsive to the sensor detects the motion for shutting off the first blower system.

Yet another aspect of the present invention is directed to an oven for heating food including a plurality of oven modules. Each oven module includes a heating compartment having first and second opposing side walls, a food support surface for supporting food to be heated, an open front in open communication with a surrounding environment outside the oven, and an open top in open communication with the surrounding environment outside the oven. Each oven module includes a housing including a back housing section, a first side housing section extending forward from the back housing section alongside the first side wall of the heating compartment, and a second side housing section extending forward from the back housing section alongside the second side wall of the first heating compartment. Gas flow openings are provided in the first side wall. A blower blows gas through the gas flow openings into the heating compartment for flow onto the food supported by the food support surface. A heater heats gas blowing into the heating compartment through the gas flow openings. The oven modules are stackable one on top of the other such that a bottom wall of an upper oven module closes the open top of a lower oven module below the upper oven module.

Other objects and features will be in part apparent and in part pointed out hereinafter.

### BRIEF DESCRIPTION OF THE DRAWINGS

FIG. 1 is a front perspective of a first embodiment of an oven of this invention;

FIG. 2 is a view similar to that of FIG. 1 but showing a food support of an upper heating compartment removed;

FIG. 3 is a front elevation of the oven of FIG. 1;

FIG. 4 is a rear perspective of the oven, a portion of the oven housing being broken away to expose an interior of the housing;

FIG. 5 is a section taken widthwise of the oven as viewed from the front of the oven;

FIG. 6 is a section taken along the depth of the oven as viewed from the right side of the oven;

FIG. 7 is a perspective of an embodiment of a food support of the oven;

FIG. 8 is a perspective of another embodiment of a food support of the oven;

FIG. 9 is a front perspective of another embodiment of an oven of this invention;

FIG. 10 is a front elevation of the oven of FIG. 9;

FIG. 11 is a front perspective of an upper oven module of the oven of FIG. 9;

FIG. 12 is a view similar to FIG. 11 but showing a food support of the oven module removed;

FIG. 13 is a rear perspective of the oven module of FIG. 11, portions of the housing of the oven module being broken away to expose an interior of the oven module;

FIG. 14 is a section taken widthwise of the oven module of FIG. 11 as viewed from the front of the oven module;

FIG. 15 is a section taken along the depth of the oven module of FIG. 11 as viewed from the right side of the oven module;

FIG. 16 is a front perspective of another oven module of the oven of FIG. 9;

FIG. 17 is a section taken along the width of the oven module of FIG. 16 as viewed from the front of the oven module;

FIG. 18 is a section taken along the depth of the oven module of FIG. 16 as viewed from the right side of the oven module;

FIG. 19 is a perspective of another embodiment of an oven of this invention;

FIG. 20 is a section taken widthwise of the oven of FIG. 19 as viewed from the front of the oven;

FIG. 21 is a perspective of another embodiment of an oven module of this invention;

FIG. 22 is a section taken widthwise of the oven module of FIG. 21 as viewed from the front of the oven module;

FIG. 23 is a perspective of another embodiment of an oven of this invention;

FIG. 24 is an exploded perspective of the oven of FIG. 23;

FIG. 25 is a perspective of a food support of the oven of FIG. 23;

FIG. 26 is a perspective of a filter of the oven of FIG. 23;

FIG. 27 is a section taken lengthwise of the filter as viewed from the right side of the filter;

FIG. 28 is a perspective of a receptacle of the oven of FIG. 23;

FIG. 29 is a perspective of the oven of FIG. 23 having an upper wall and control housing removed to expose a food holding assembly;

FIG. 30 is a perspective of the food holding assembly;

FIG. 31 is a section taken lengthwise of the food holding assembly through an intermediate heating compartment as viewed from the right side of the food holding assembly;

FIG. 32 is a section taken widthwise of the food holding assembly as viewed from the front of the food holding assembly;

FIG. 33 is a perspective of the food holding assembly without the food support, filter, and receptacle; and

FIG. 34 is a perspective of the food holding assembly without the food support.

Corresponding reference characters indicate corresponding parts throughout the drawings.

### DETAILED DESCRIPTION

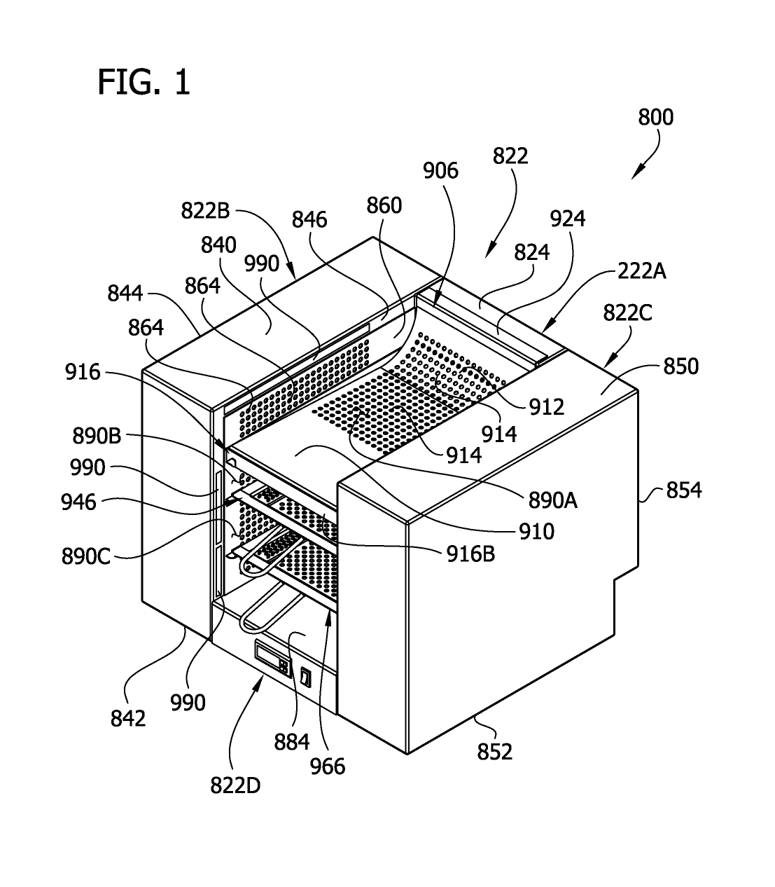

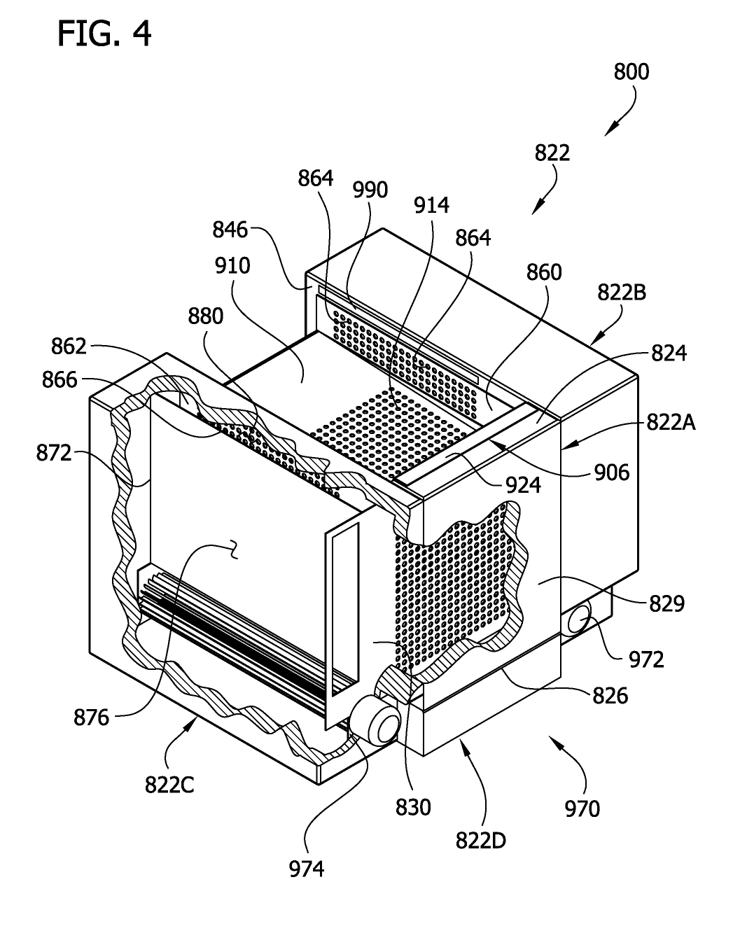

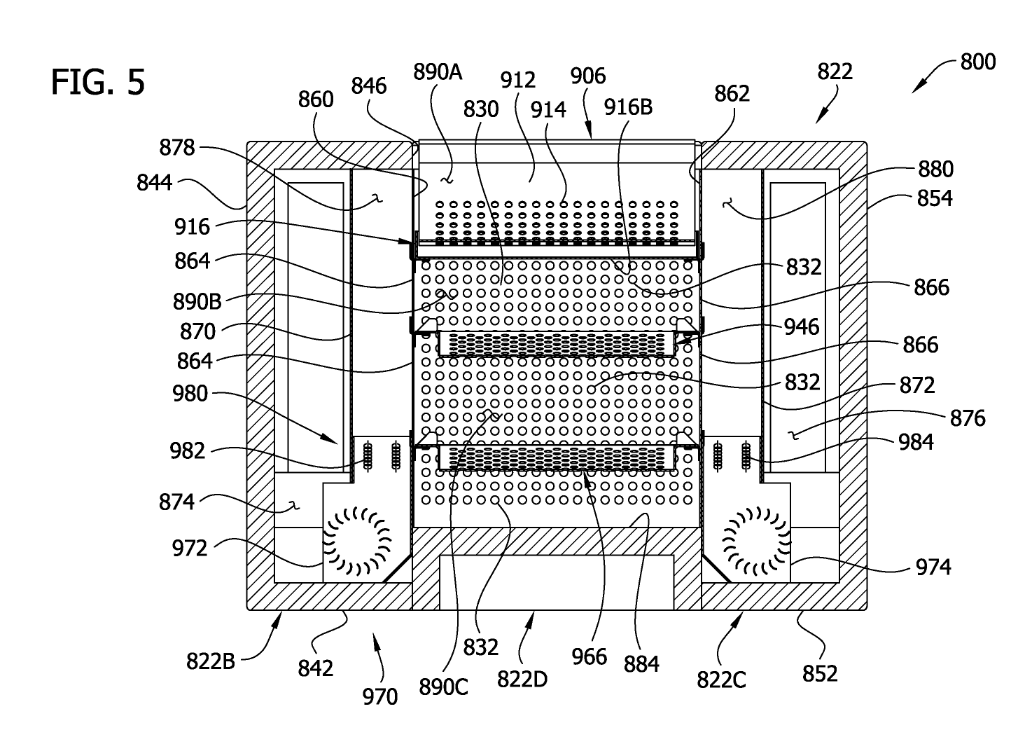

Referring now to the drawings, and more particularly to FIGS. 1-8, an oven of this invention for heating food with heated gas (e.g., air) is designated in its entirety by the reference number 800. The oven may be used for heating various types of food, such as potato fries, onion rings, and other fried foods or non-fried foods. The oven 800 includes a U-shaped housing, generally designated 822, comprising a back housing section 822A, and first (left) and second (right) housing sections 822B, 822C extending forward from opposite ends of the back housing section. The back housing section 822A includes a top wall 824, a bottom wall 826, a back wall 829, and a front wall 830 having gas flow openings 832 therein. The side housing section 822B includes a top wall 840, a bottom wall 842, an outer side wall 844, and an inner side wall 846, and the side housing section 822C includes a top wall 850, a bottom wall 852, an outer side wall 854, and an inner side wall 856. The opposing inner side walls 846, 856 of the two housing side sections 822B, 822C comprise removable gas discharge plates 860, 862 having respective gas flow openings 864, 866 therein. Each side section 822B, 822C includes a respective vertical partition 870, 872 which extends the length of the housing side section and divides the interior of the housing side section into an outer plenum space 874, 876 adjacent the outer side wall 844, 854 and an inner plenum space 878, 880 adjacent the inner side wall 846, 856 (see FIG. 5). As illustrated in FIG. 5, the partitions are spaced above the bottom walls 842, 852 of the housing side sections 822B, 822C to provide a gas flow area through which gas (e.g., air) may flow from the outer plenum space to the inner plenum space.

The housing 822 also includes a control section 822D extending between the side sections 822B, 822C at the bottom of the housing. The control section 822D houses controls for the oven and includes a top wall 884. Desirably, the oven has a suitable control system 230 for operating the oven. The control system may include an on/off power switch and an operator input for inputting desired operational information such as compartment temperature, heating time, and specific programs for heating (e.g., rethermalizing) and/or holding food in the oven. The control system may also include a processor (not shown) for processing such information and controlling gas flow and heat accordingly.

The oven 800 has an oven cavity comprising at least one heating compartment located between the two side housing sections and above the control section. In this particular embodiment, the cavity comprises three heating compartments or zones, namely, an upper heating compartment 890A, a middle heating compartment 890B below the upper compartment, and a lower heating compartment 890C below the middle heating compartment. The number of heating compartments (zones) can vary from one to two or more.

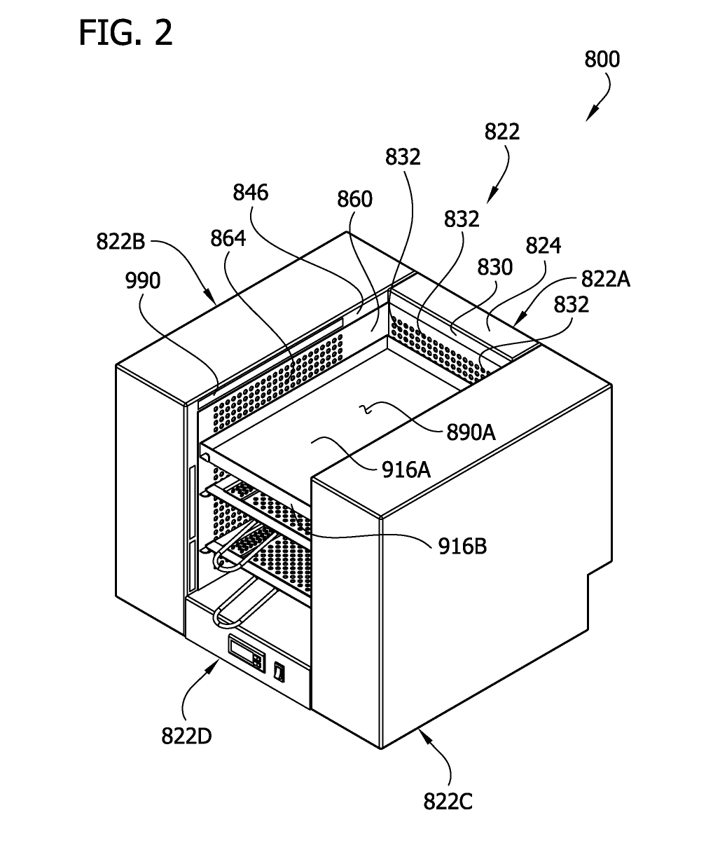

The upper heating compartment or zone 890A is topless, that is, it has a top which is open to the environment surrounding the oven 800. The compartment 890A also has a front which is open to the environment. There is no door closing the front of the compartment 890A. The upper heating compartment 890A further comprises opposing left and right side walls defined by upper regions of the housing side walls 846, 856, and a back side wall defined by an upper region of the front wall 830 of the back housing section 822A. The heating compartment 890A comprises a food support or platform 906. The food support 906 is shown in the heating compartment in FIG. 1 and removed from the heating compartment in FIG. 2. In the illustrated embodiment, the food support 906 comprises a perforated wall having a food support surface including a substantially smooth planar forward region 910 and a substantially smooth back region 912 curving upward from the forward region to facilitate scooping food off the food support surface. The back region 912 of the food support 906 is spaced forward from and relatively close to the front wall 830 of the back section 822A of the housing 822. The forward region 910 and upwardly-curved region 912 of the food support surface of the food support 906 have perforations 914 to permit heated gas and particles on the food to pass through the food support. Desirably, the food support 906 is supported on a catch pan 916 (as best viewed in FIG. 2, in which the food support 906 is not shown) for catching particles (e.g., salt and food particles) that fall through the perforations 914. The catch pan 916 includes a non-perforated bottom wall 916A and an upstanding peripheral rim 916B. In the illustrated embodiment, the food support 906 includes a flange 922 which extends downward from a forward end of the forward region 910 which rests on the catch pan 916. The food support 906 is also supported and positioned by a flange 924 which extends rearward from the upper end of the upwardly curved back region 912 and overlaps the top wall 824 of the back section 822A of the housing 822.

The food support 906 may be fabricated as a single part from suitable material (e.g., stainless steel) or from multiple parts secured together in such a way that the upper surfaces of the forward region 910 and upwardly curved region 912 combine to form a smooth continuous food support surface to facilitate the removal of food from the food support 906 of the upper heating compartment 890A using a scooping motion. The actual removal can be carried out by using a scoop or similar implement, or by moving a food package (e.g., a carton) in a scooping motion to transfer food from the scoop member directly into the package. The forward region 910 of the food support 906 may have a small front-to-back downward slope to facilitate the scooping process. As food is pushed in front-to-back direction along the food support surface of the food support 906, food on the upwardly curved region 912 tends to gravitate down into the scoop or package to fill it.

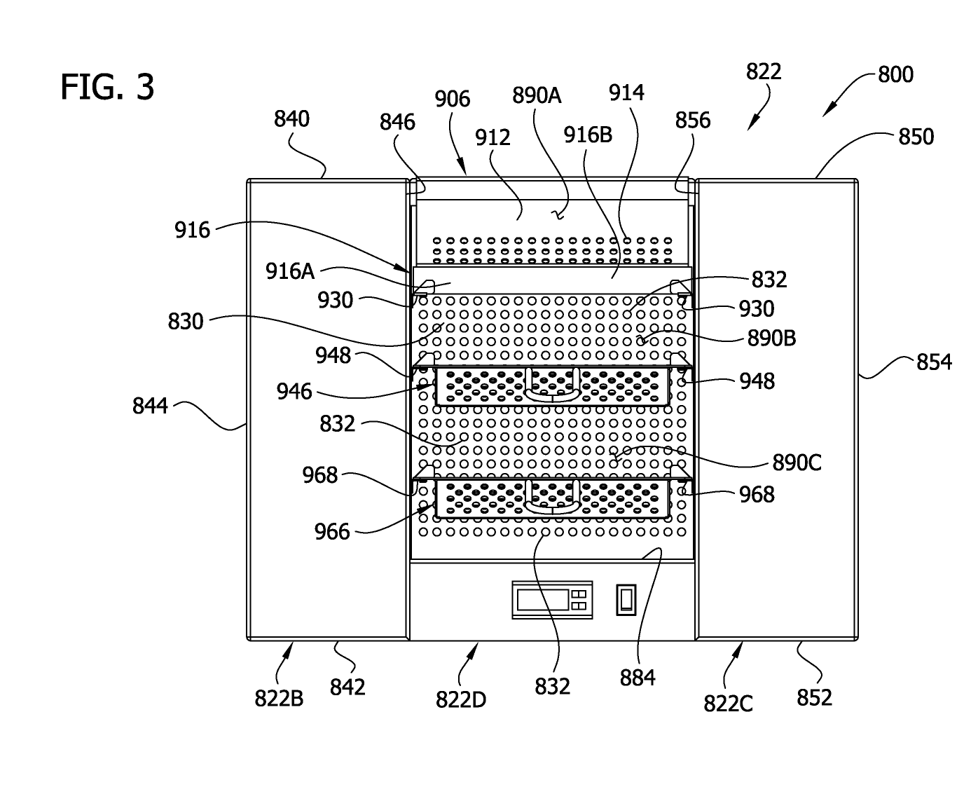

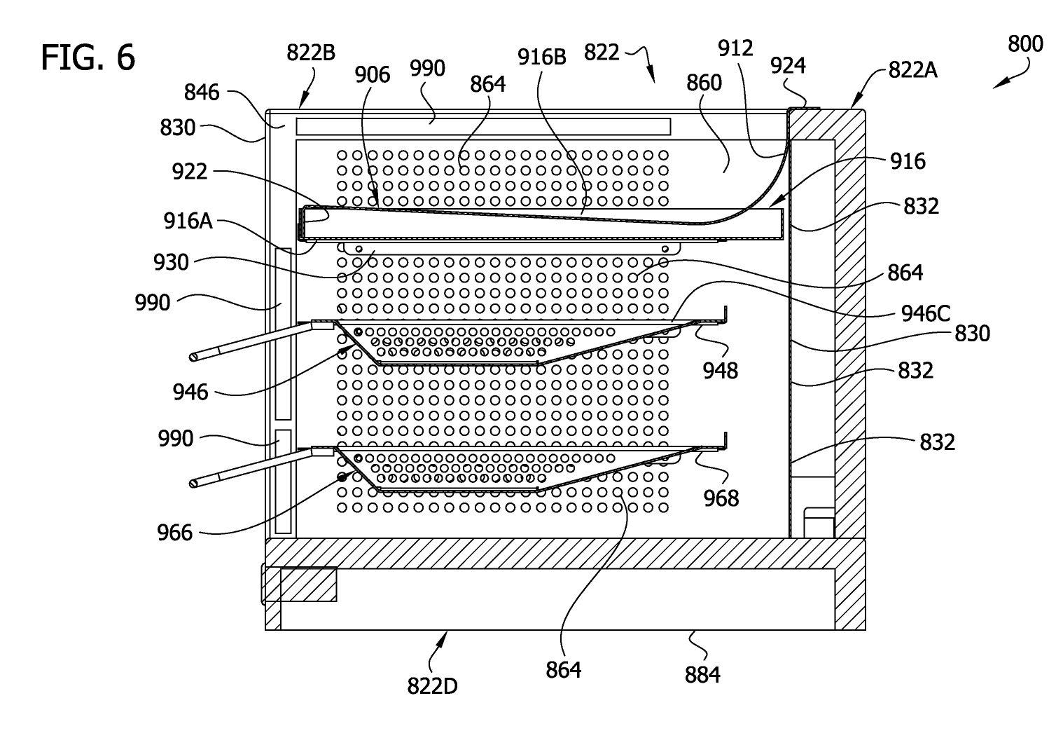

Desirably, the food support 906 is fabricated as a separate member for being easy removable from the oven 800 (e.g., for cleaning), as shown by example without limitation by comparison of FIGS. 1 (food support 906 installed) and 2 (food support removed). By way of example, as noted above, the food support 906 may rest on the catch pan 916. Other mounting arrangements are possible. Similarly, the catch pan 916 is mounted for removal from the oven 800. In the illustrated embodiment, the catch pan 916 rests on supports comprising horizontal slide rails 930 (FIGS. 3 and 6) attached to the inner side walls 846, 856 of the housing side sections 822B, 822C.

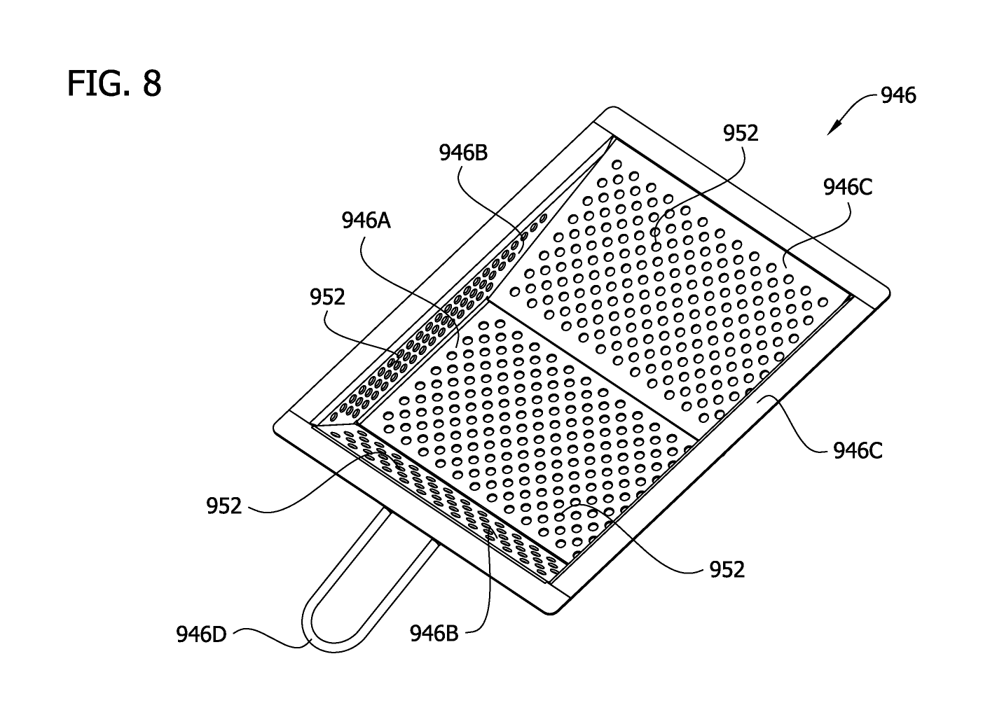

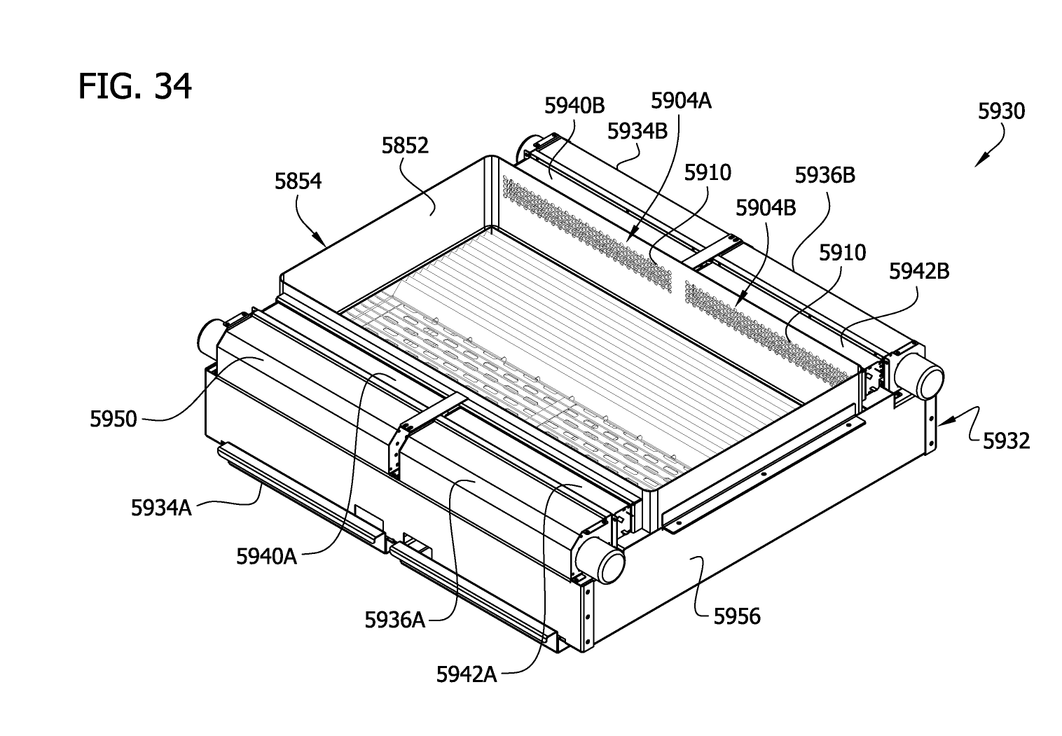

The middle heating compartment or zone 890B has an open front, opposing side walls defined by middle regions of the housing side walls 846, 856, a back wall defined by a middle region of the front wall 830 of the back housing section 822A, and a top wall defined by the bottom wall 918 of the catch pan 916. Food in the middle heating compartment 890B is held by a middle food support or platform (tray) 946 supported in the compartment by supports comprising horizontal slide rails 948 (FIGS. 3 and 6) attached to the middle regions of the side walls. The food support 946 is shown in closest detail in FIG. 8. In the illustrated embodiment, as shown in FIG. 34, the middle food support 946 comprises a tray having perforations 952 in bottom and side walls 946A, 946B, a top rim 946C that rests on the slide rails 948, and a handle 946D for holding the tray. The perforations 952 in the tray 946 allow salt and other food particles to fall from the tray and permit gas to flow through the tray.

The lower heating compartment or zone 890C has an open front, opposing side walls defined by lower regions of the housing side walls 846, 856, and a back wall defined by a lower region of the front wall 830 of the back housing section 822A. The middle and lower heating compartments 890B, 890C are separated by the middle food support 946 (if used). Food in the lower heating compartment 890C is held on a lower food support 966 supported in the compartment by supports comprising horizontal slide rails 968 (FIGS. 3 and 6) attached to the lower regions of the side walls 846, 856. Alternatively, the lower food support 966 may be supported in the compartment 890C by setting it on the bottom wall 884 of the oven cavity. The lower food support 966 is preferably identical to the middle food support 946 (see FIG. 8), but it may have other configurations.

The oven 800 also includes a blower system 970 comprising a first blower 972 in the first side housing section 922B and a second blower 974 in the second side housing section 922C. The blowers 972, 974 are mounted in the gas flow areas adjacent the bottom walls 842, 852 of the housing sections 822B, 822C such that the inlets of the blowers communicate with respective outer plenums 874, 876, and the outlets of the blowers communicate with respective inner plenums 878, 880 for blowing gas from the inner plenums into the outer plenums. The blowers 972, 974 are preferably variable speed blowers. Gas exiting the blower system 970 is heated by a heater system 980, which in the illustrated embodiment comprises a first heater 982 in the inner plenum 878 of the first side housing section 822B and a second heater 984 in the inner plenum 880 of the second side housing section 822C. The heaters 982, 984 may be electric heaters with open coil heating elements capable of delivering substantial heat quickly to the gas passing by the heating elements. Other types of heaters, including finned heaters, may be used without departing from the scope of the present invention. Desirably, the heaters 982, 984 are connected to the blowers 972, 974 by means of a direct connection (e.g., a flange connection) with no intervening ductwork between the respective blowers and heaters. By way of example but not limitation, the blower and heater combination may be of the type commercially available from LTG Incorporated, product designation LTG Tangential Fan TAh. Alternatively, the heaters 982, 984 may be incorporated as an integral part of the blowers 972, 974.

In other embodiments, the blower system 970 may comprise a single blower in combination with ductwork for routing gas from the blower to the gas flow openings in the first and second side walls of the heating compartment. Similarly, the heater system 980 may comprise a single heater or two or more heaters for heating the gas before it exits the gas flow openings in the side walls.

Gas heated by the heater system 980 is directed into respective inner plenums 878, 880 and through the respective gas flow openings 864, 866 in the inner side walls 846, 856 of the first and second housing side sections 822B, 822C. The gas flow openings 864, 866 direct the heated gas into the upper, middle, and lower heating compartments (zones) 890A-890C for heating food held on respective food supports 906, 946, 966 in the compartments. The gas flow openings 864, 866 may be configured such that substantially all of the gas blowing into the heating compartments 890A-890C is directed generally away from the open fronts of the compartments. Desirably, the gas may also be directed in a downwardly angled direction toward the food in respective compartments or zones 890A-890C. Heated gas flowing into the upper heating compartment 890A passes through the perforations 914 in the food support 906 in the compartment. Heated gas flowing into the middle and lower compartments 890B, 890C passes through the perforated middle and lower food supports 946, 966 (if used). The flow of heated gas across the food and around the food via the perforations helps to hold the heat in hot food placed in the compartments 890A-890C, thereby extending the holding time for the food.

The gas discharge plates 860, 862 containing the gas flow openings 864, 866 in the side walls 846, 856 may be removable and replaceable by discharge plates having gas flow openings of a different configuration. In this way, the volume and/or direction of gas flow into the heating compartments 890A-890C can be varied, as needed or desired. The gas discharge plates may be fixed (not removable) without departing from the scope of the present invention.

Gas exits the upper, middle, and lower compartments 890A-890C through the gas flow openings 832 in the back walls of the compartments (the front wall 830 of the back housing section 822A). Gas in the interior of the back housing section 822A exits into the outer plenums 874, 876 of the housing side sections 822B, 822C for recirculation through the first and second blowers 972, 974 and heaters 982, 984. Suitable filters (not shown) including catalysts or other devices may be used to clean the air.

Optionally, one or more motion sensors 990 may be provided for detecting the motion of a hand, arm, or scoop within the heating compartments 890A-890C. Referring to FIGS. 1 and 6, three such motion sensors are shown. A first motion sensor 990 is positioned adjacent the open top of the upper heating compartment 890A for detecting the motion of a hand, arm, or scoop within the upper heating compartment. Second and third motion sensors 990 are positioned adjacent the open fronts of the middle and lower heating compartments 890B, 890C. A control (not shown) in the control housing is responsive to the sensors detecting any such motion for shutting off the blower system 970. When the hand, arm, or scoop is removed from the heating compartment 890A-890C, the blower system may be reenergized. This may occur, for example without limitation, based on the sensors 990 no longer indicating motion in the heating compartments 890A-890C, or based on a countdown of a predetermined time from when motion was sensed.

In operation, hot food from a fryer, for example, is placed on the food support 906 in the upper heating compartment 890A. Additional hot food may also be placed on the middle food support 946 in the middle compartment 890B and/or the lower food support 966 in the lower compartment 890C. The food is heated and held in the compartments at the desired temperature and under the desired conditions by the delivery of heated gas through respective gas flow openings 864, 866. When hot food is ready to be served, it is removed from the upper compartment 890A using a scooping motion, as described above. When the supply of food in the upper compartment 890A needs to be replenished, the middle food support 946 or lower food support 966 may be removed for transferring its contents to the upper compartment 890A. If the contents of the middle food support 946 are transferred, the lower food support 966 may be moved up to the middle compartment 890B. The emptied middle or lower food support 946, 966 is refilled with a batch of freshly fried food and placed in the middle or lower compartment 890B, 890C, depending on which is empty. In this manner, batches of food are moved from a lower compartment (zone) 890B, 890C up to the upper compartment 890A in a progressive manner to maximize the volume of food that can be held during periods when high volumes of food are needed while minimizing the risk that any one batch will become stale and/or lose quality. During periods of lower volume, one or both of the middle and lower food supports 946, 966 may not need to be used or filled.

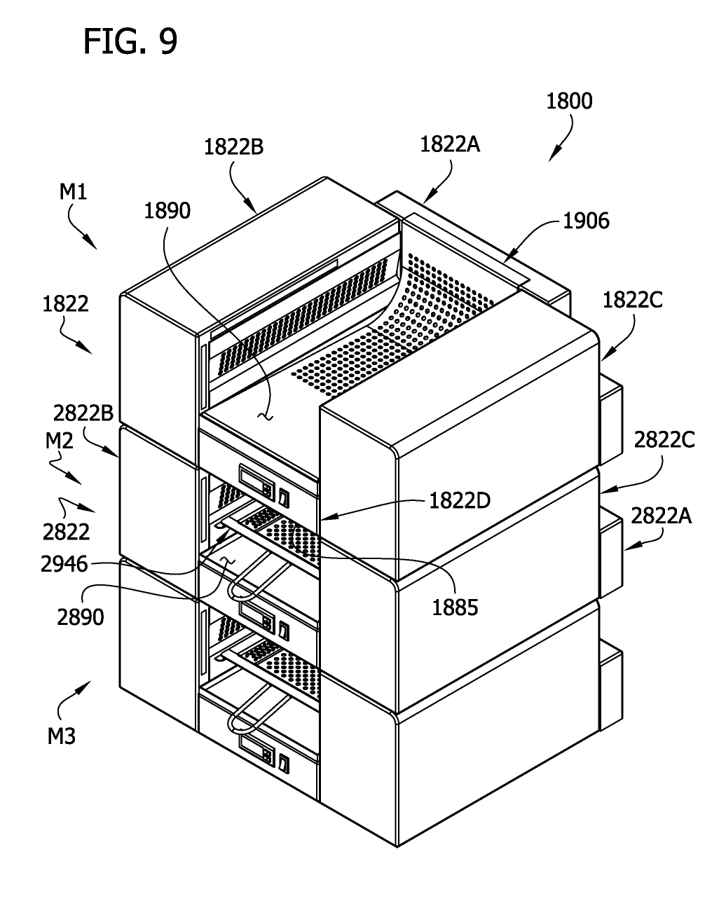

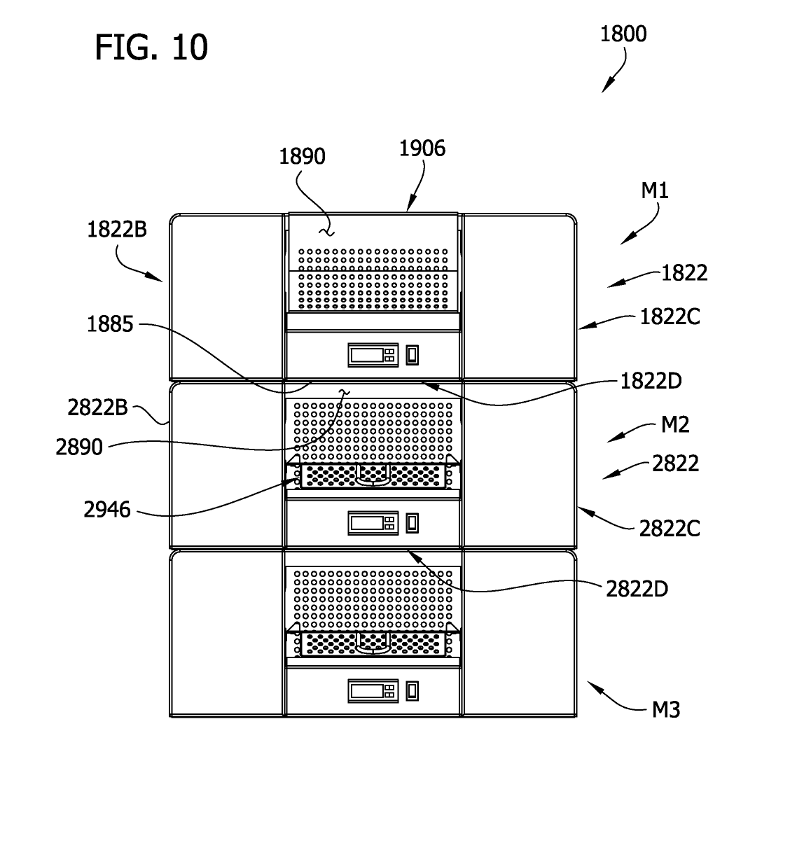

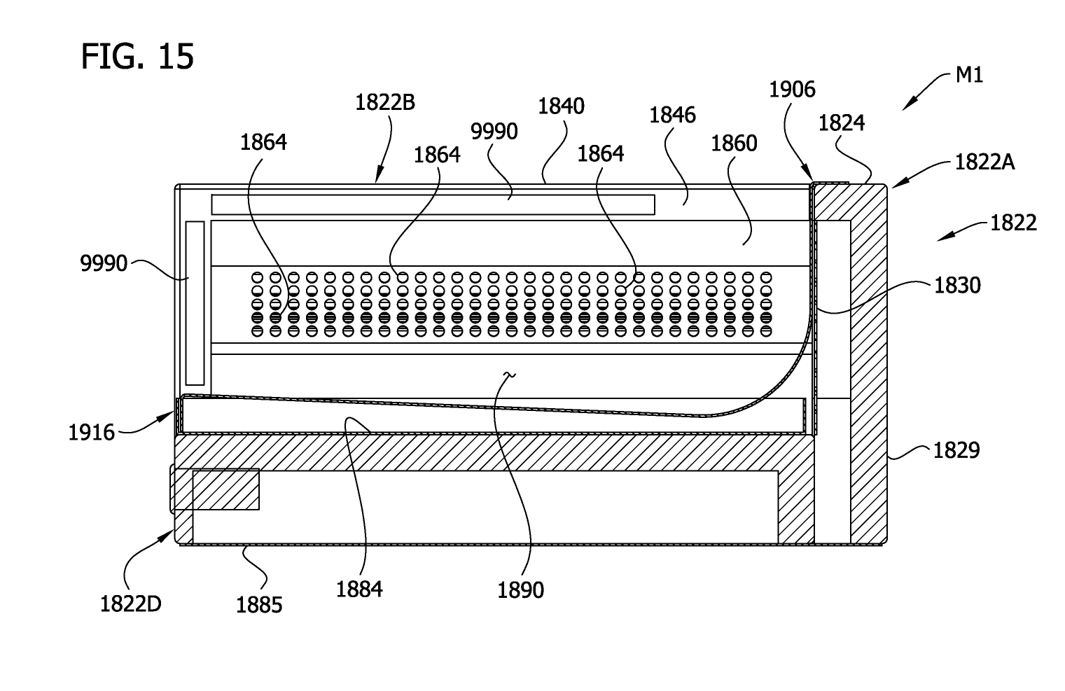

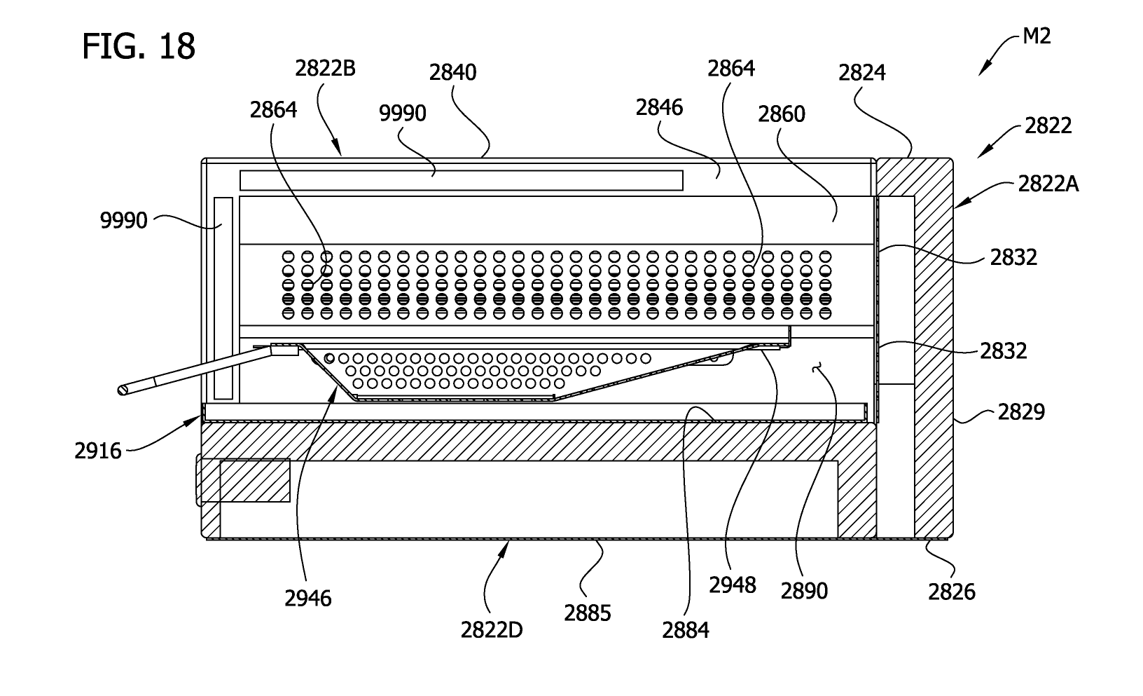

FIGS. 9-18 illustrate another embodiment of an oven of this invention, generally designated 1800. The oven comprises a plurality of oven modules. Three such modules M1, M2, M3 are shown, but this number can vary. As will be described, the modules M1-M3 are stackable one on top of another to conserve space while providing a large food holding capacity. As will become apparent, the oven modules M1-M3 have open top heating compartments, and the open tops may be closed by stacking the heating modules.

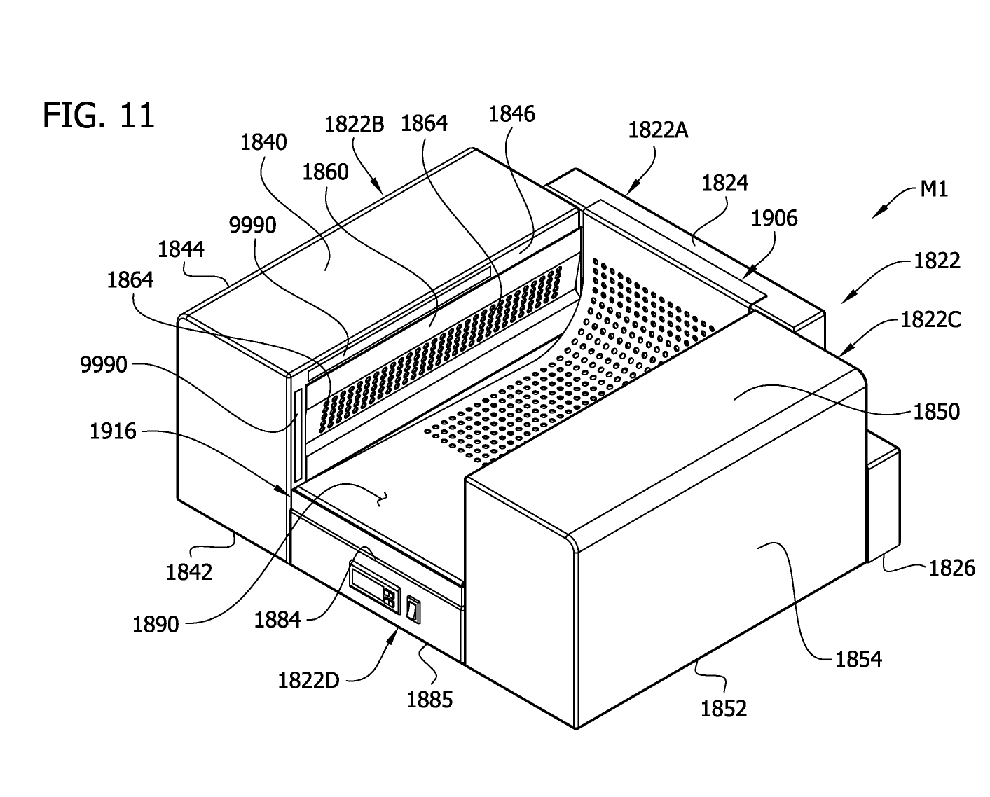

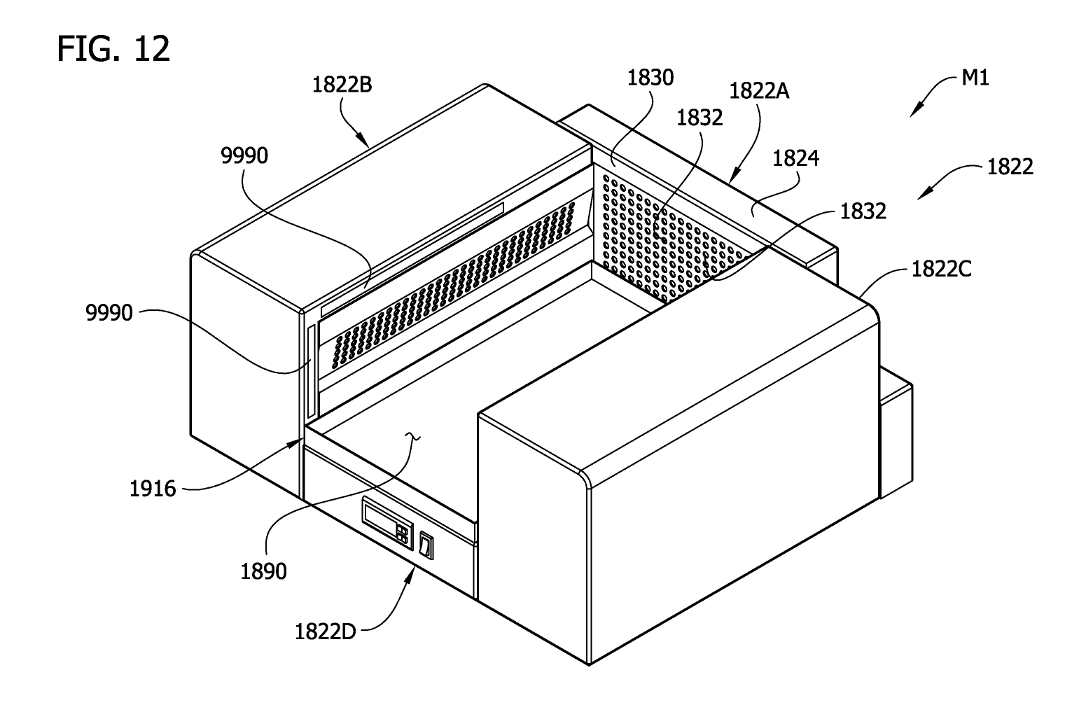

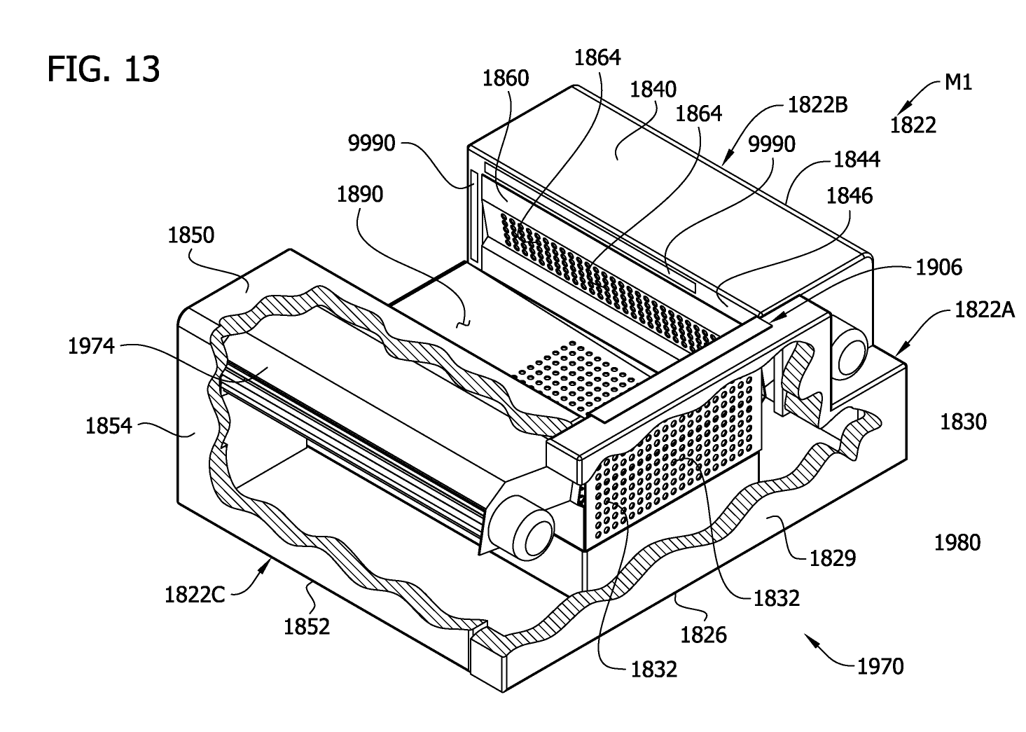

Referring to FIGS. 11-15, the upper module M1 is similar to the oven 800 of the previous embodiment, and corresponding parts are designated by the same reference numbers increased by 1000. The module M1 is different than the oven 800 in that the module has only one heating compartment 1890. The module M1 comprises a U-shaped housing, generally designated 1822, comprising a back housing section 1822A, and first (left) and second (right) housing sections 1822B, 1822C extending forward from opposite ends of the back housing section. The back housing section 1822A includes a top wall 1824, a bottom wall 1826, a back wall 1829, and a front wall 1830 (FIGS. 12 and 13) having gas flow openings 1832 therein. The first side housing section 1822B includes a top wall 1840, a bottom wall 1842, an outer side wall 1844, and an inner side wall 1846, defining an interior space or plenum. The second side housing section 1822C includes a top wall 1850, a bottom wall 1852, an outer side wall 1854, and an inner side wall 1856, defining an interior space or plenum. The opposing inner side walls 1846, 1856 of the two housing side sections 1822B, 1822C comprise respective removable gas discharge plates 1860, 1862 having gas flow openings 1864, 1866 therein.

The housing 1822 of the oven module M1 also includes a control section 1822D extending between the side sections 1822B, 1822C at the bottom of the housing. The control section 1822D houses the controls for the oven and includes a top wall 1884 and a bottom wall 1885.

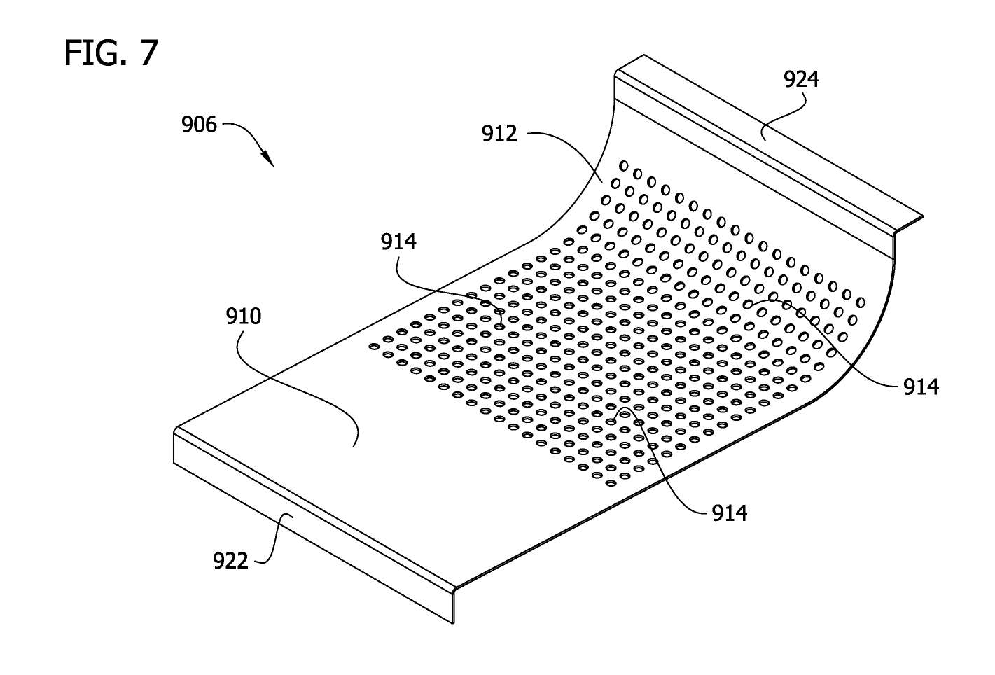

The oven module M1 has an oven cavity having one and only one heating compartment 1890 located between the two side housing sections 1822B, 1822C and above the control section 1822D. The heating compartment 1890 is topless, that is, it has a top which is open to the environment surrounding the oven. The front of the heating compartment 1890 is also open to the surrounding environment (it has no door). The heating compartment 1890 has two opposing side walls on the left and right sides of the compartment defined by regions of the housing inner side walls 1846, 1856, and a back wall defined by a region of the front wall 1830 of the back housing section 1822A. The heating compartment 1890 comprises a food support or platform 1906 including a food support surface for supporting food to be heated. The food support is shown in the heating compartment 1890 in FIG. 11 and removed from the heating compartment in FIG. 12. The food support 1906 comprises a perforated wall of food support surface identical to the food support 906 of the previous embodiment (see FIG. 7). Desirably, the food support 1906 is supported by a catch pan 1916 which is positioned to catch particles (e.g., salt and food particles) that fall through perforations 1914 in the food support. As best shown in FIG. 12, the catch pan 1916 has a construction identical to the catch pan 916 of the previous embodiment. In the illustrated embodiment, the catch pan 1916 is supported by the top wall 1884 of the control section 1822D of the housing 1822, but it will be understood that it may be supported in other ways (e.g., by supports on the side walls of the heating compartment).

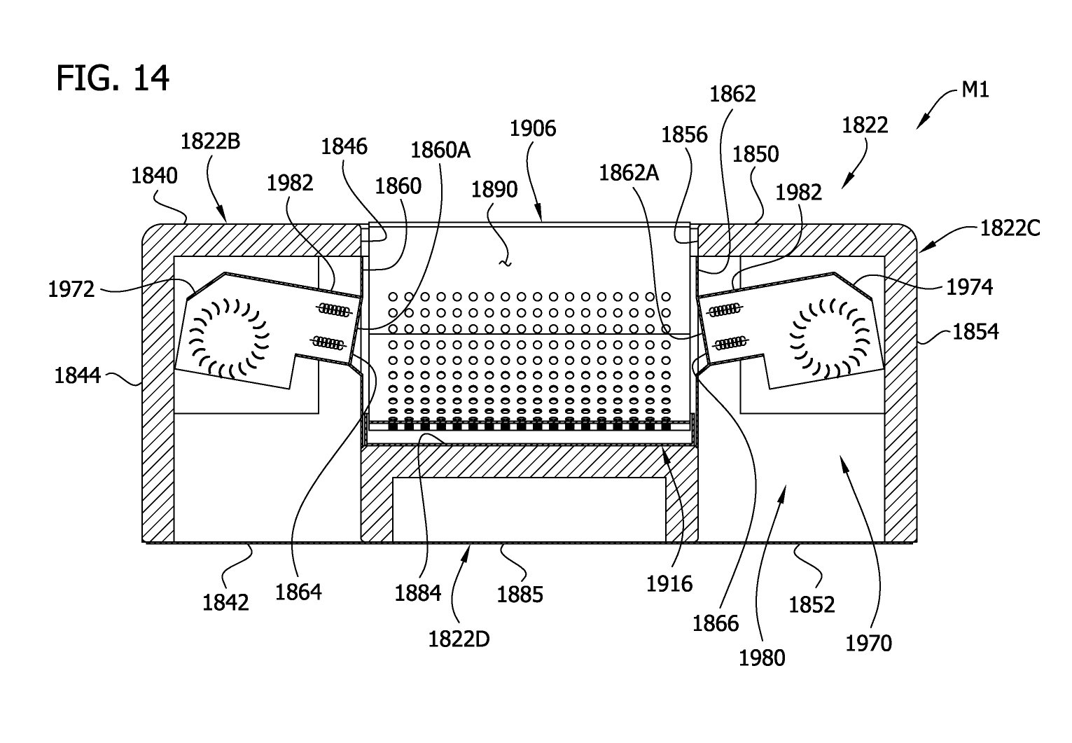

The oven module M1 includes a blower system 1970 (FIGS. 13 and 14) for blowing gas through the gas flow openings 1864, 1866 in the side walls 1846, 1856 of the heating compartment 1890. In the illustrated embodiment, the blower system 1970 comprises a first blower 1972 mounted in the interior space of the first housing side section 1822B, and a second blower 1974 mounted in the interior space of the second housing side section 1822C. The blowers 1972, 1974 are preferably variable speed blowers. In other embodiments, the blower system 1970 may comprise only one blower in combination with ductwork for routing gas from the blower to the gas flow openings in both side walls of the heating compartment 1890.

The module M1 also includes a heater system 1980 (FIGS. 13 and 14) for heating the gas. The heater system 1980 comprises a first heater 1982 associated with the first blower 1972 and a second heater 1984 associated with the second blower 1974. The heaters 1982, 1984 are mounted in respective interior spaces of the first and second housing side sections 1822B, 1822C. In some embodiments, the heater system 1980 may comprise only one heater or two or more heaters for heating the gas blown into the heating compartment 1890.

In the illustrated embodiment, each blower 1972, 1974 has an inlet communicating with a respective interior space, and an outlet. Gas from the blower 1972, 1974 is heated by its respective heater 1982, 1984 in or adjacent the outlet of the blower. The heater 1982, 1984 may be an electric heater with open coil heating elements capable of delivering substantial heat quickly to the gas passing by the heating elements. Other types of heaters, including finned heaters, may be used without departing from the scope of the present invention. Desirably, the heaters 1982, 1984 are connected to their respective blowers 1972, 1974 by means of a direct connection (e.g., a flange connection) with no intervening ductwork between the blower and the heater. By way of example but not limitation, the blower and heater combination may be of the type commercially available from LTG Incorporated, product designation LTG Tangential Fan TAh. Alternatively, the heaters 1982, 1984 may be incorporated as an integral part of the blowers 1972, 1974. In any event, the heater/blower unit is desirably supported in the respective housing side section 1822B, 1822C (e.g., attached to the inner side wall 1846, 1856) such that heated gas (e.g., air) leaving the unit passes directly through the gas flow openings 1864, 1866 and into the heating compartment 1890, preferably without intervening ductwork between the unit and the inner side wall.

Referring to FIG. 14, the blower/heater units adjacent the side walls 1846, 1856 of the heating compartment 1890 are mounted such that the outlets of the units are immediately adjacent and face to face with regions 1860A, 1862A of a the gas discharge plates 1860, 1862 containing gas flow openings 1864, 1866. These regions 1860A, 1862A are angled off vertical to direct the flow of heated gas at a downwardly inclined angle with respect to horizontal toward the food on the food support 1906 in the heating compartment 1890. This gas flow angle is desirably in the range of 5 to 40 degrees, even more desirably in the range of 15 to 30 degrees, and about 25 degrees with respect to horizontal in the illustrated embodiment.

As a result of the arrangement described above, heated gas flowing into the heating compartment 1890 through gas flow openings 1864, 1866 in opposite side walls 1846, 1856 of the compartment forms a generally downwardly converging pattern or X pattern converging toward the food on the food support 1906 in the heating compartment 1890. This downwardly converging pattern of heated gas flow may be achieved using gas discharge plates having a configuration other than the angled-region configuration described above and shown in the drawings.

Other configurations of gas flow may be used without departing from the scope of the present invention. For example, the discharge plates may be substantially upright (not angled off vertical), and the discharged gas may flow substantially horizontally into the heating compartment.

The gas flow openings 1864, 1866 may be configured such that substantially all of the gas blowing into the heating compartment 1890 is directed generally away from the open front of the compartment. Heated gas flowing into the heating compartment 1890 passes through the perforated food support, including the perforated food support region 1910 and the perforated back region 1912. The flow of heated gas across the food and around the food via the perforations 1914 in the food support 1906 helps to hold the heat in hot food placed in the compartment 1890, thereby extending the holding time for the food.

The gas discharge plates 1860, 1862 containing gas flow openings 1864, 1866 of a first configuration may be removable and replaceable by discharge plates containing gas flow openings having a second configuration different from the first configuration. In this way, the volume and/or direction of gas flow into the heating compartment 1890 can be varied, as needed or desired. The gas discharge plates may be fixed (not removable) without departing from the scope of the present invention.

Gas exits the heating compartment 1890 of the oven module M1 through the perforated food support 1906 and the through the gas flow openings 1832 in the front wall 1830 of the back housing section 1822A. Gas in the interior of the back housing section 1822A exits into the plenums of the housing side sections for recirculation through respective blower/heater units 1972, 1982, 1974, 1984. Suitable filters (not shown) including catalysts or other devices may be used to clean the air.

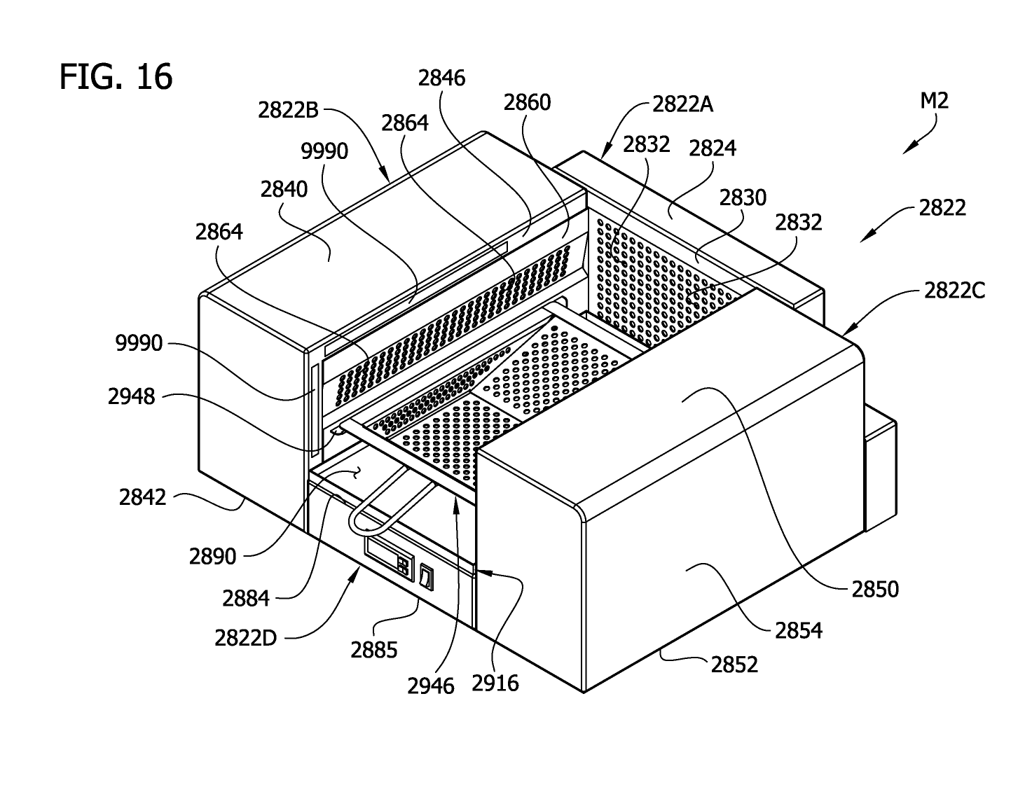

Referring to FIGS. 16-18, the oven module M2 is similar to the module M1, and corresponding parts are designated by the same reference numbers increased by 1000.

The module M2 comprises a U-shaped housing, generally designated 2822, including a back housing section 2822A, and first (left) and second (right) housing sections 2822B, 2822C extending forward from opposite ends of the back housing section. The back housing section 2822A includes a top wall 2824, a bottom wall 2826, a back wall 2829, and a front wall 2830 having gas flow openings 2832 therein. The first side housing section 2822B includes a top wall 2840, a bottom wall 2842, an outer side wall 2844, and an inner side wall 2846, defining an interior space or plenum. The second side housing section 2822C includes a top wall 2850, a bottom wall 2852, an outer side wall 2854, and an inner side wall 2856, defining an interior space or plenum. The opposing inner side walls 2846, 2856 of the two housing side sections 2822B, 2822C comprise removable gas discharge plates 2860, 2862 having gas flow openings 2864, 2866 therein.

The housing 2822 of the oven module M2 also includes a control section 2822D extending between the side sections 2822B, 2822C at the bottom of the housing 2822. The control section 2822D houses the controls for the oven module M2 and includes a top wall 2884 and a bottom wall 2885.

The oven module M2 comprises an oven cavity having one and only one heating compartment 2890 located between the two side housing sections 2822B, 2822C and above the control section 2822D. Like the oven module M1, the heating compartment 2890 of module M2 is topless, at least until it is combined with module M1. When module M1 is positioned on module M2, as illustrated, the bottom wall 1885 of the control housing of module M1 functions as a top wall for the heating compartment 2890 of module M2.

The heating compartment 2890 of module M2 has an open front (no door), two opposing side walls defined by regions of the housing side walls 2846, 2856, and a back wall defined by a region of the front wall 2830 of the back housing section 2822A. The heating compartment 2890 includes a food support or platform (tray) 2946 having a support surface for supporting food to be heated. In the illustrated embodiment, the food support 2946 comprises a food tray identical to the food support 946 of the previous embodiment (see FIG. 8). The food support 2946 is supported in the heating compartment 2890 by supports comprising horizontal rails 2948 attached to the side walls 2846, 2856 of the heating compartment. Food particles falling through the perforations in the support surface of the food support 2946 fall into a catch pan 2916 positioned adjacent the bottom of the heating compartment 2890 on the top wall 2884 of the control section 2822D of the housing 2822.

The second oven module M2 includes a second module blower system 2970 comprising a first blower 2972 mounted in the interior space of the first housing side section 2922B and a second blower 2974 mounted in the interior space of the second housing side section 2922C. The blowers 2972, 2974 have inlets communicating with the interior spaces of the side sections 2922B, 2922C and have outlets. The blowers 2972, 2974 are preferably variable speed blowers. Gas from the blowers 2972, 2974 is heated by a heater system 2980 comprising a first heater 2982 in or adjacent the outlet of the first blower 2972 and a second heater 2984 in or adjacent the outlet of the second blower 2974. The heaters 2982, 2984 may be electric heaters with open coil heating elements capable of delivering substantial heat quickly to the gas passing by the heating elements. Desirably, the heaters 2982, 2984 are connected to the blowers 2972, 2974 by means of a direct connection (e.g., a flange connection) in which there is no intervening ductwork between the blowers and the respective heaters, thus forming a first blower/heater unit. By way of example but not limitation, the blower/heater unit may of the type commercially available LTG Incorporated, product designation LTG Tangential Fan TAh. Alternatively, the heaters 2982, 2984 may be incorporated as an integral part of the blowers 2972, 2974. In any event, the blower/heater units are desirably attached to the inner side walls 2846, 2856 of the housing side sections 2822B, 2822C such that heated gas (e.g., air) leaving the units passes directly through the gas flow openings 2864, 2866 and into the heating chamber 2890, preferably without intervening ductwork between the unit and the inner side walls.

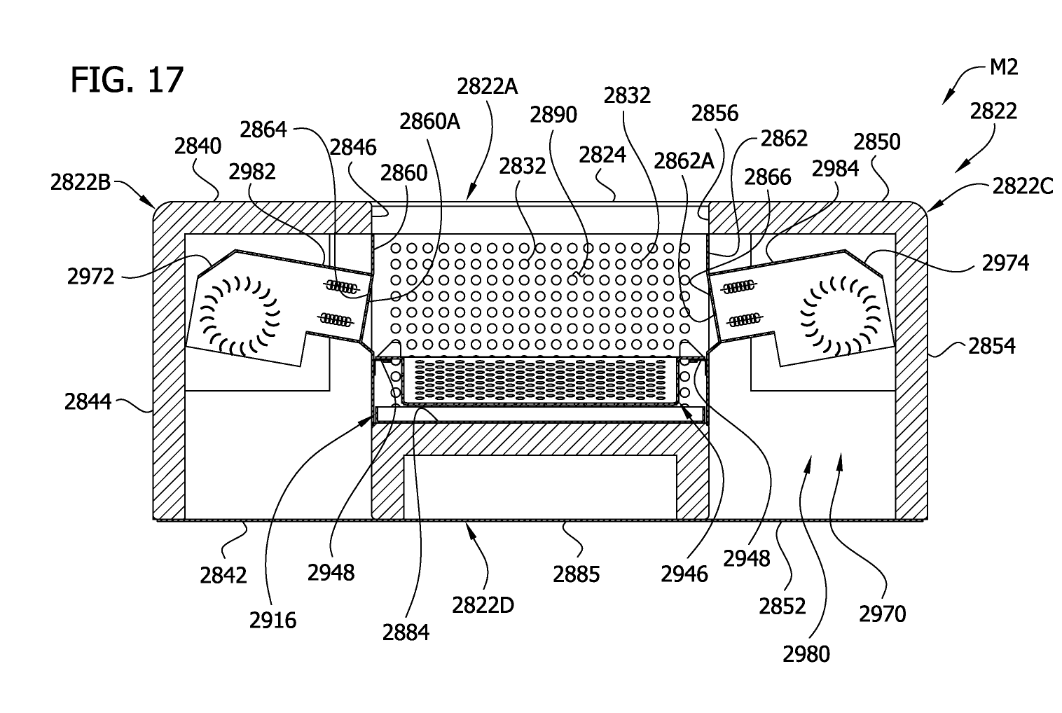

Referring to FIG. 17, the blower/heater units 2972, 2982, 2974, 2984 of the second module M2 are mounted such that the outlets of the units are immediately adjacent and face to face with respective regions 2860A, 2862A of the gas discharge plates 2860, 2862 containing the gas flow openings 2864, 2866. These regions 2860A, 2862A are angled off vertical to direct the flow of heated gas at a first downwardly inclined angle with respect to horizontal toward food held on the food support 2946. This gas flow angle is desirably in the range of 5 to 40 degrees, even more desirably in the range of 15 to 30 degrees, and about 25 degrees with respect to horizontal in the illustrated embodiment.

As a result, heated gas flowing into the heating compartment 2890 through the gas flow openings 2864, 2866 in opposite side walls 2846, 2856 of the heating compartment 2890 of module M2 forms a generally downwardly converging pattern or X-pattern converging toward the food support 2946 in the heating compartment 2890. This downwardly converging pattern of heated gas flow may be achieved using gas discharge plates having a configuration other than the angled-region configuration described above and shown in the drawings.

Other configurations of gas flow may be used without departing from the scope of the present invention. For example, the discharge plates may be substantially upright (not angled off vertical), and the discharged gas may flow substantially horizontally into the heating compartment.

Air flow through the heating compartment 2890 of the second oven module M2 may be identical the air flow through the heating compartment 1890 of the first oven module M1. The gas flow openings 2864, 2866 may be configured such that substantially all of the gas blowing into the heating compartment 2890 is directed generally away from the open front of the compartment. Heated gas flowing into the heating compartment 2890 passes through the perforated food support 2946. The flow of heated gas across the food and around the food via the perforations helps to hold the heat in hot food placed in the compartment 2890, thereby extending the holding time for the food.

As described in connection with oven module M1, the gas discharge plates 2860, 2862 of the second oven module M2 are removable and replaceable by discharge plates containing gas flow openings having a configuration different from the gas flow openings in the removed discharge plates. In this way, the volume and/or direction of gas flow into the heating compartment 2890 can be varied, as needed or desired.

Gas exits the heating compartment 2890 of the oven module M2 through the gas flow openings 2832 in the back wall of the heating compartment (the front wall 2830 of the back housing section 2822A). Gas in the interior of the back housing section 2822A exits into the plenums of the housing side sections 2822B, 2822C for recirculation through respective blower/heater units 2972, 2982, 2974, 2984. Suitable filters (not shown) including catalysts or other devices may be used to clean the air.

The oven module M3 is essentially identical to module M2 and need not be described further.

Optionally, one or more motion sensors 9990 may be provided for detecting the motion of a hand, arm, or scoop within the heating compartment 1890, 2890 of each module M1, M2, M3. As shown in FIGS. 11, 15, 16, and 18 motion sensors 9990 are provided adjacent the open fronts and open tops of the compartments 1890, 2890 for detecting the motion of a hand, arm, or scoop within the heating compartments. Other arrangements of sensors may be used, and one or more of the sensors may be omitted, without departing from the scope of the present invention. Controls (not shown) in the respective control housings 1822D, 2822D are responsive to the sensors 9990 detecting any such motion for shutting off the appropriate blower systems 1970, 2970 corresponding to the heating compartment(s) 1890, 2890 in which the motion is detected. When the hand, arm, or scoop is removed from the heating compartment 1890, 2890, the blower system 1970, 2970 may be reenergized. This may occur based on the sensor(s) 9990 no longer indicating motion in the upper heating compartment, or based on a countdown of a predetermined time from when motion was sensed.

Desirably, the modules M1, M2, M3 are operable independent of one another and without communication with one another. Alternatively, the modules M1, M2, M3 can incorporate a master/slave model of communication in which one of the modules (e.g., module M1) has control over the other module(s) M2, M3.

Any number of oven modules M1, M2, M3 may be stacked one on top of another, depending on volume and space needs. The modular feature of the oven 1800 allows the oven to handle high volumes of food product while conserving counter space. For example without limitation, stacking module M1 on top of module M2 closes the open top of the compartment 2890 of module M2 with the bottom wall 1885 of the module M1.

In operation, hot food from a fryer, for example, is placed on the food support surface of the food support 1906, which is configured for scooping, in the heating compartment 1890 of the upper module M1. Additional hot food may also be placed on the food support surface of the food support 2946 in the heating compartment 2890 of any one or more of the lower modules M1 and M2. The food is heated and held in the compartments 1890, 2890 at the desired temperature and under the desired conditions by the delivery of heated gas through respective gas flow openings 1864, 1866, 2864, 2866. When hot food is ready to be served, it is removed from the upper compartment 1890 using a scooping motion, as described above. When the supply of food in the upper module M1 needs to be replenished, the food support 2946 of the module M2 or module M3 is removed and its contents are transferred from its food support surface to the food support surface of the food support 1906 of the module M1. If the contents of module M2 are transferred to the module M1, the food support 2946 in module M3 may be moved up to the compartment 2890 of module M2. The food support 2946 emptied into the module M1 is refilled with a batch of freshly fried food and placed in the heating compartment 2890 of module M2 or module M3, depending on which module is empty. In this manner, batches of food are moved from the heating compartment 2890 of one of the lower modules M2, M3 up to the heating compartment 1890 of the upper module M1 to maximize the volume of food that can be held during periods when high volumes of food are needed while minimizing the risk that any one batch will become stale and/or lose quality. During periods of lower volume, one or both of the food supports in modules M2 and M3 may not need to be used or filled.

The upper module M1 is readily convertible to a module like M2 or M3 simply by removing the curved food support 1906. Conversely, a lower module like module M2 or M3 can be readily converted to an upper module like M1 simply by installing the curved food support 1906 on the module. The ease of this conversion process is advantageous in the event one of the modules needs to be repaired or replaced. When converting a module M1, M2, M3, it may be desirable to replace the gas discharge plates 1860, 1862, 2860, 2862 with plates which have or do not have support rails for supporting a food support in the heating compartment, as desired.

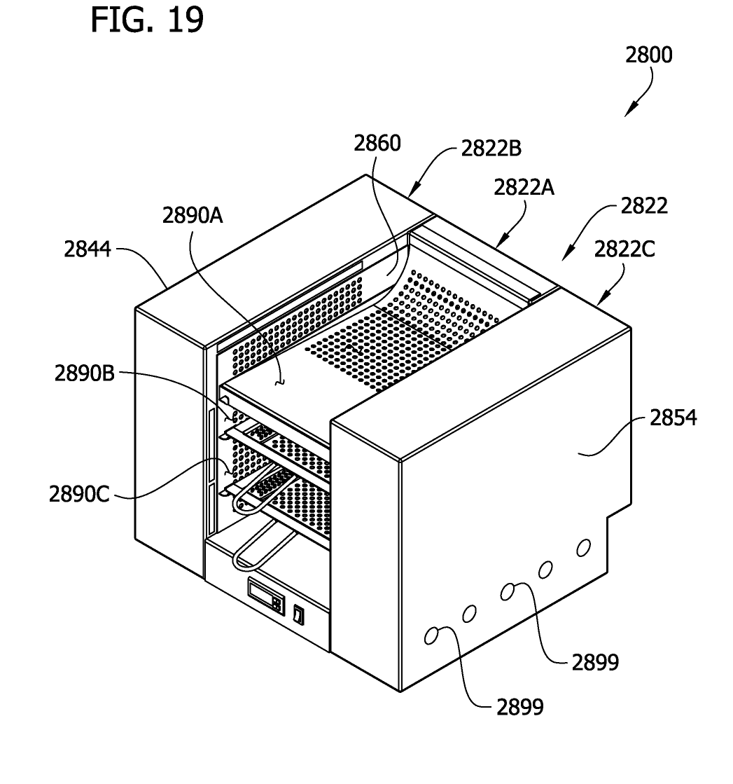

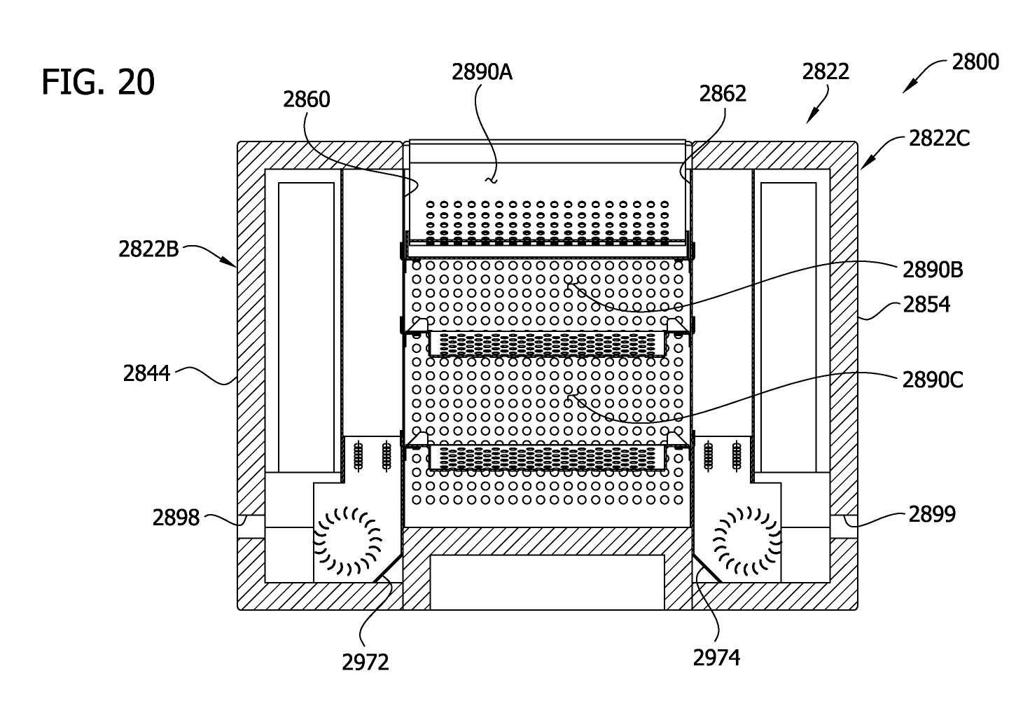

FIGS. 19 and 20 illustrate another embodiment of an oven of this invention, generally designated 2800. The oven is substantially the same as the oven 800 shown in FIG. 11, and similar parts are designated by the same reference numbers, plus “2000.” For example, the oven 2800 includes a housing, generally designated 2822, comprising a back housing section 2822A, and first (left) and second (right) housing sections 2822B, 2822C. The oven 2800 also includes an upper heating compartment 2890A, a middle heating compartment 2890B, and a lower heating compartment 2890C, and gas discharge plates 2860, 2862. In this embodiment, the oven 2800 includes vents including multiple vent openings 2898, 2899 providing communication between the open environment outside the oven 2800 and the housing interior. The vent openings 2898, 2899 are illustrated as being provided in the outer side walls 2844, 2854 of the respective left and right side housing sections 2822B, 2822C upstream from the blowers 2972, 2974, such that the blowers draw ambient air in through the vent openings via negative pressure. Other configurations of vents may be used without departing from the scope of the present invention. For example, more or fewer vent openings may be used, and the vent openings may be provided in other locations. The vent openings 2898, 2899 may be provided for supplying the blower system (blowers 2974, 2972) with ambient gas for blending with gas re-circulated from the heating compartments 2890A-2890C. This may be useful in achieving a desired temperature of gas delivered to the heating compartments 2890A-2890C. It may also be desirable to deliver only ambient gas to the heating compartments 2890A-2890C. For example, it may be desirable to actively cool food held in the heating compartments 2890A-2890C using gas drawn through the vent openings 2898, 2899 and blowing it unheated into the heating compartments. Suitable flow control devices such as selectively openable and closeable valves or shutters may be used for regulating (e.g., preventing) re-circulating flow from the heating compartments and/or regulating (e.g., preventing) ambient flow through the vent openings 2898, 2899 per control signals from the oven controller.

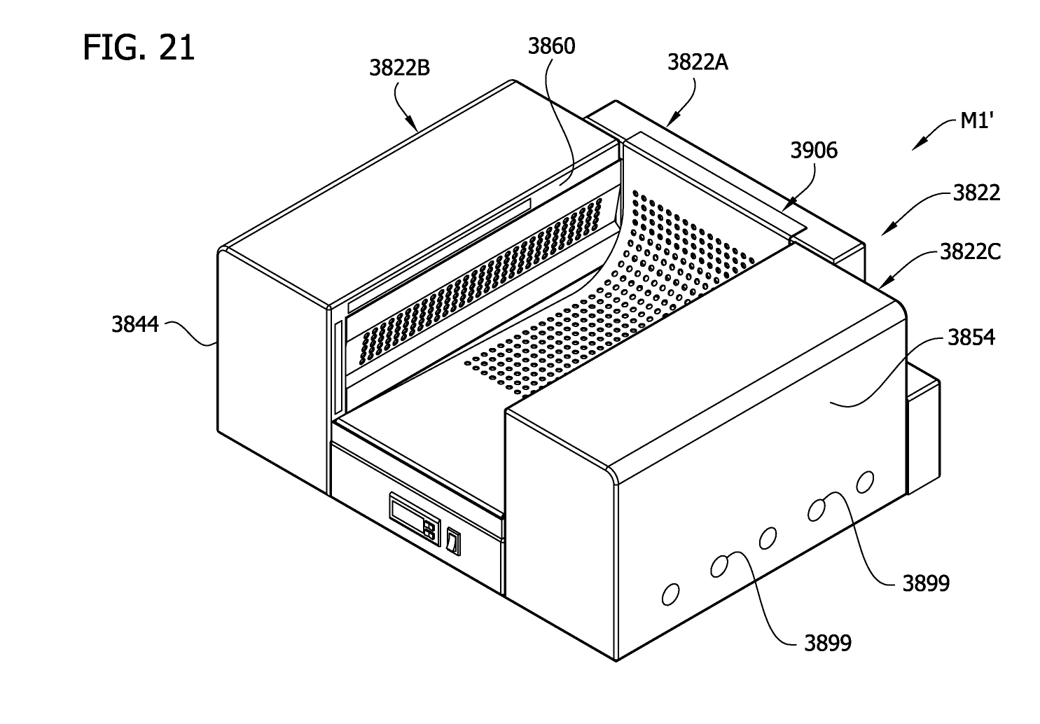

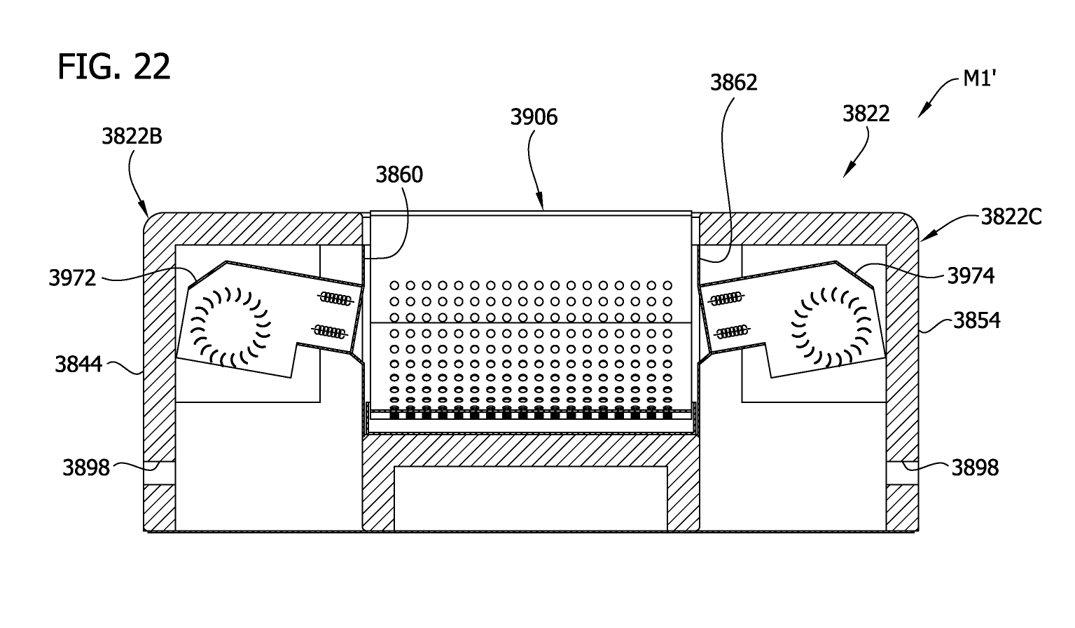

FIGS. 21 and 22 illustrate another embodiment of an oven module of this invention, generally designated M1′. The oven module is substantially the same as the oven module M1 shown in FIG. 11, and similar parts are designated by the same reference numbers, plus “2000.” For example, the oven module M1′ includes a housing, generally designated 3822, comprising a back housing section 3822A, first (left) and second (right) housing sections 3822B, 3822C, a heating compartment 3890, gas discharge plates 3860, 3862, and a food support 3906. In this embodiment, the oven module M1′ includes vents including multiple vent openings 3898, 3899 providing communication between the open environment outside the oven module M1′ and the housing interior. The vent openings 3898, 3899 are illustrated as being provided in the outer side walls 3844, 3854. Other positions and configurations of vents may be used without departing from the scope of the present invention. It will be understood the vents may be used and/or provided with associated structure (e.g., valves, shutters) substantially the same as described above with respect to the vent openings 2898, 2899 of FIGS. 19 and 20.

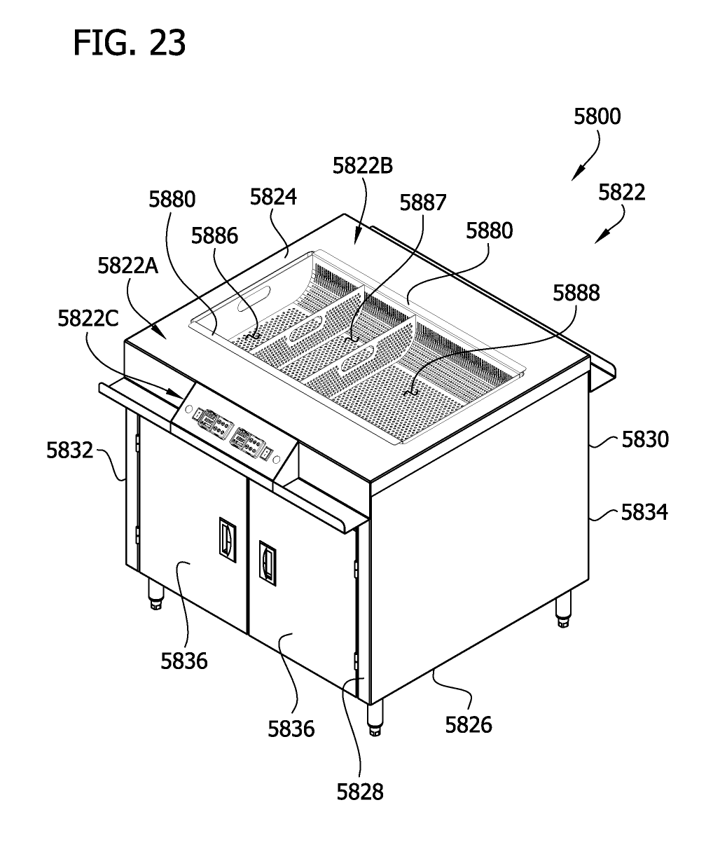

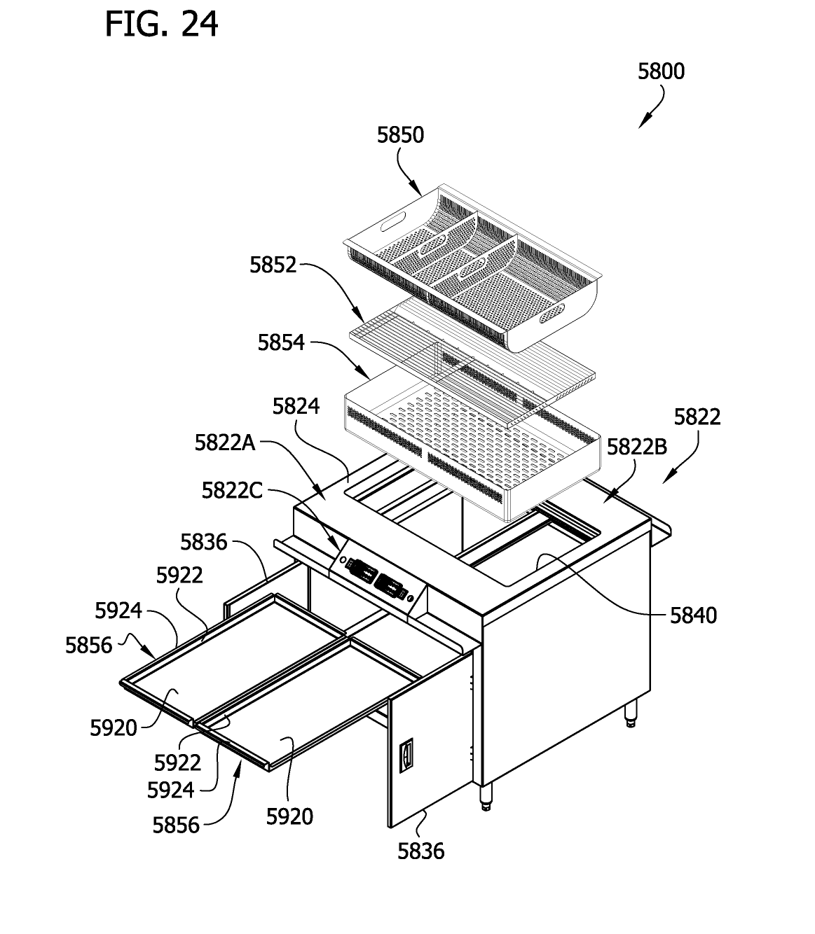

Referring now to FIGS. 23-34, another embodiment of an oven of this invention is generally designated by the reference number 5800. Like other embodiments disclosed herein, the oven 5800 is adapted for heating food with heated gas (e.g., air), and the oven may be used for heating various types of food, such as potato fries, onion rings, and other fried foods or non-fried foods. The oven 5800 includes a housing, generally designated 5822 having an interior bounded by a plurality of walls, including an upper wall 5824, a bottom wall 5826, front and back side walls 5828, 5830, and left and right side walls 5832, 5834. The housing 5822 has a width extending between the left and right side walls 5832, 5834 and a length extending between the front and back walls 5828, 5830. A lower portion of the interior of the housing 5822 is accessible for storage via an opening in the front wall 5828 selectively opened and closed by doors 5836. In the illustrated embodiment, the upper wall 5824 of the housing 5822 functions as a countertop, although only limited countertop space is provided. In other embodiments, more or less countertop space may be provided (e.g., no countertop space). The housing 5822 includes an upper opening 5840 (FIG. 24), which in the illustrated embodiment is provided in the upper wall 5824. The housing 5822 includes front and back housing sections 5822A, 5822B positioned in front of and behind the opening 5840, respectively. The front and back housing sections 5822A, 5822B extend widthwise of the housing 5822 between the left and right sides of the housing. As will become apparent, equipment for blowing and/or heating gas (e.g., air) may be supported in the front and/or back housing sections 5822A, 5822B.

The housing 5822 also includes a control section 5822C. In the illustrated embodiment, the control section 5822C is provided at the front of the housing 5822 above the doors 5836. The control section 5822C houses controls for the oven 5800 and includes on/off switches and operator inputs for controlling operation of the oven.

Referring to FIG. 24, several components of the oven 5800 are shown removed from the housing 5822. These components include a food support 5850, a filter 5852, a receptacle 5854, and catch pans 5856. In general, and as will be described in further detail below, heated gas is delivered to food supported on the food support 5850, the gas is exhausted into the interior of the housing 5822 through the filter 5852 and receptacle 5854, and the gas is re-heated and re-circulated to the food on the food support. Particles and oil which may fall from the food are collected on the catch pans 5856 for disposal. Desirably, the food support 5850, filter 5852, and receptacle 5854 are removable from the housing 5822 via the upper opening 5840 in the housing. The catch pans 5856 are removable via the front of the housing 5822 by opening the doors 5836. When assembled, the receptacle 5854 extends downward below the upper opening 5840 of the housing 5822 and receives the filter 5852 and lower portion of the food support 5850. Other arrangements may be used without departing from the scope of the present invention. For example, the food support 5850, filter 5852, and/or receptacle 5854 may not be removable or may be removable in other ways, and the catch pans 5856 may be removable in other ways, without departing from the scope of the present invention. Moreover, components such as the receptacle 5854, filter 5852, and catch pans 5856 may be omitted without departing from the scope of the present invention. The various components will be described in further detail below.

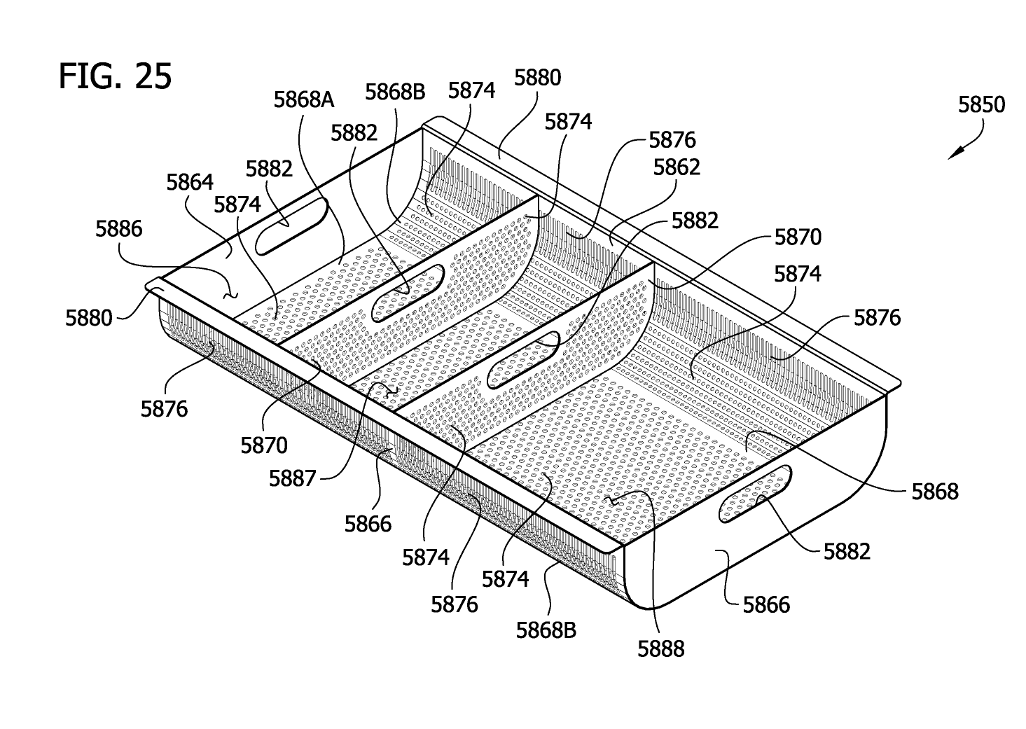

As shown in FIG. 25, in the illustrated embodiment, the food support 5850 comprises a basket-shaped member including a front wall 5860, a rear wall 5862, left and right side walls 5864, 5866, and a bottom wall 5868. The bottom wall 5868 comprises a substantially smooth planar region 5868A and substantially smooth forward and back regions 5868B curving upward from the planar region, which facilitates scooping food out of the food support 5850. The front and back walls 5860, 5862 extend upward from the forward and back curved regions 5868B of the bottom wall 5862. The left and right side walls 5864, 5866 extend upward from the bottom wall 5868 and extend between the front and back walls 5860, 5862 to close the left and right sides of the food support 5850. First and second intermediate walls or partitions 5870 between the left and right side walls 5864, 5866 extend upward from the bottom wall 5868 and extend between the front and back walls 5860, 5862.

The bottom wall 5862, front and back side walls 5860, 5862, and intermediate walls 5870 include gas flow openings or perforations 5874, 5876 to permit gas flow through the walls and to permit particles (e.g., salt or crumbs) and oil to pass through the walls. The gas flow openings 5874 in the bottom wall 5868 and partitions 5870 are relatively small generally circular openings arranged in arrays including columns and rows of gas flow openings. The gas flow openings 5876 in the front and back side walls 5860, 5862 comprise generally elongate slot-shaped openings extending vertically along the front and back side walls. The gas flow openings 5876 in the front and back side walls 5860, 5862 are arranged in rows extending along the length of the front and back side walls. Other configurations (e.g., number, size, arrangement) of gas flow openings 5874, 5876 may be used without departing from the scope of the present invention. For example, the gas flow openings 5874 in the intermediate walls 5870 may be omitted, and the gas flow openings 5874 in the curved forward and back portions 5868B of the bottom wall 5868 may be omitted.

The food support 5850 includes flanges 5880 extending between the left and right side walls 5864, 5866 of the food support 5850 at upper ends of the front and back side walls. The flanges 5880 overlie edge margins of the upper wall 5824 of the housing 5822 in front of and behind the opening 5840. Similar flanges may also be provided on the left and right sides of the food support 5850, if desired. The flanges 5880 may suspend the food support 5850 in and extending below the upper opening 5840 of the housing 5822. Alternatively, the food support 5850 may rest on the filter 5852 and/or receptacle 5854 below the opening 5840. In that case, the flanges 5880 may be omitted. Desirably, the flanges 5880 prevent food from entering the housing 5822 through the annular gap between the peripheral edge of the upper opening 5840 and the food support 5850. Other mounting arrangements for the food support 5850 may be used without departing from the scope of the present invention.

The food support 5850 includes handles 5882 in the form of openings sized for receiving fingers. The handles 5882 are provided on the left and right side walls 5864, 5866 and on the partitions 5870. The handles 5882 may be used for removing the food support 5850 from the housing 5822 for cleaning the food support 5850 and replacing the food support back in the housing. Other types of handles may be used, and the handles 5882 may be omitted, without departing from the scope of the present invention.

The food support 5850 may be fabricated from suitable material (e.g., stainless steel) as a single part or from multiple parts secured together. Desirably, the walls 5860, 5862, 5868 are constructed in such a way as to form a substantially smooth continuous interior surface to facilitate removal of food from the food support 5850 using a scooping motion, as described in further detail below.

The oven 5800 includes an open top oven cavity formed by the front, back, left, and right side walls 5860, 5862, 5864, 5866 of the food support 5850. The oven cavity includes separate open top heating compartments or “lanes” 5886-5888 which are partitioned from each other by the food support partitions 5870. In the illustrated embodiment, three heating compartments 5886-5888 are provided, namely, a first or left heating compartment 5886, a second or intermediate heating compartment 5887, and a third or right heating compartment 5888. Other numbers of heating compartments 5886-5888 (e.g., one, two, four, or more heating compartments) may be provided without departing from the scope of the present invention. For example, more than one intermediate heating compartment 5887 may be provided. In the illustrated embodiment, the heating compartments 5886-5888 are arranged in a row extending widthwise of the housing 5822 between the left and right sides of the housing. The heating compartments 5886-5888 are positioned one after another along the row. The heating compartments 5886-5888 are illustrated as being immediately beside each other but may be beside and spaced from one another without departing from the scope of the present invention.

The open top heating compartments 5886-5888 are defined by walls and/or respective portions of walls of the food support 5850. More particularly, the heating compartments 5886-5888 are defined by respective portions of the front, back, bottom, and (in the case of the left and right heating compartments 5886, 5887) respective left and right side walls 5860, 5862, 5868, 5864, 5866 of the food support 5850. The left heating compartment 5886 includes left and right side walls defined by the left side wall 5864 of the food support 5850 and the first partition 5870, front and back side walls defined by respective left portions of the front and back walls 5860, 5862 of the food support, and a lower wall including a food support surface defined by a left portion of the bottom wall 5862 of the food support. The intermediate heating compartment 5887 includes left and right side walls defined by the first and second partitions 5870, front and back side walls defined by respective intermediate portions of the front and back walls 5860, 5862 of the food support 5850, and a lower wall including a food support surface defined by an intermediate portion of the bottom wall 5868 of the food support. The right heating compartment 5888 includes left and right side walls defined by the second partition 5870 and the right side wall 5866 of the food support 5850, front and back side walls defined by respective right portions of the front and back walls 5860, 5862 of the food support, and a lower wall including a food support surface defined by a right portion of the bottom wall 5862 of the food support.

Food is supported in each heating compartment 5886-5888 on its respective food support surface. The food support surfaces, comprising respective left, intermediate, and right portions of the planar region 5868A and forward and back upwardly curved regions 5868B of the food support bottom wall 5868, are substantially smooth and continuous for facilitating removal of food from the heating compartments 5886-5888. The actual removal of food can be carried out by using a scoop or similar implement, or by moving a food package (e.g., a carton) in a scooping motion to transfer food from the scoop member directly into the package. As food is pushed in a front-to-back or back-to-front direction along the food support surface of a particular heating compartment 5886-5888, food on the upwardly curved regions of the food support surface and the front or back side wall of the heating compartment tends to gravitate down into the scoop or package to fill it. The gas flow openings or perforations 5874 in the food support surfaces permit salt and other food particles to pass through the food support surfaces and permit gas to flow through the food support surfaces. Although the gas flow openings 5876 in the front and back side walls 5860, 5862 are shown as having the same configuration for each of the heating compartments 5886-5888, it will be understood that they may be different from each other (e.g., for providing different gas flow volume or direction in different food compartments).

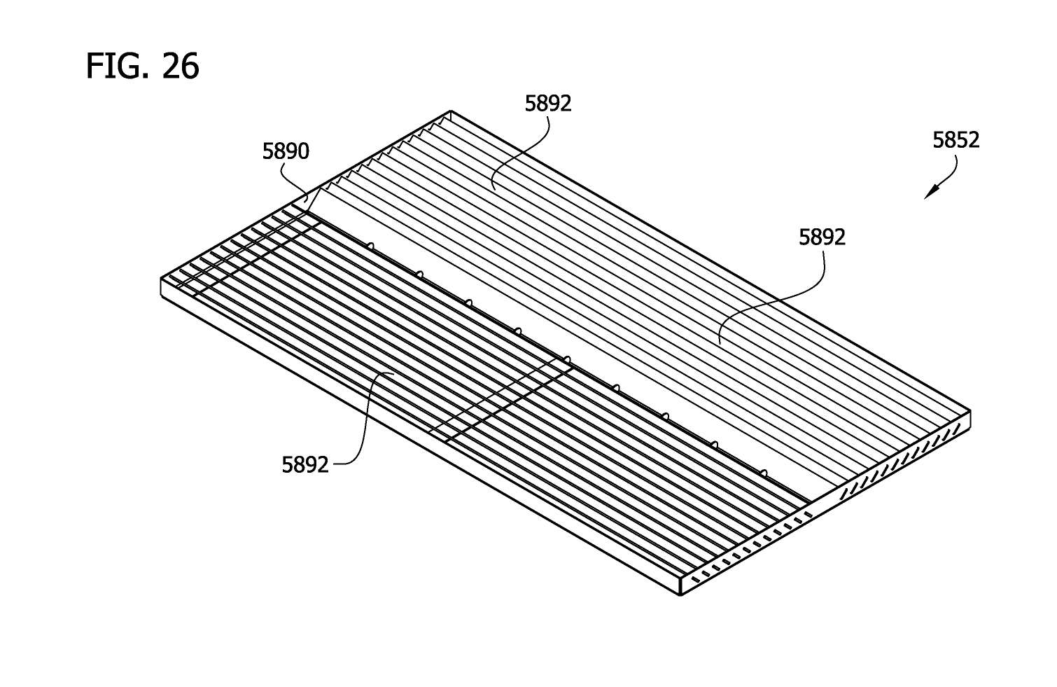

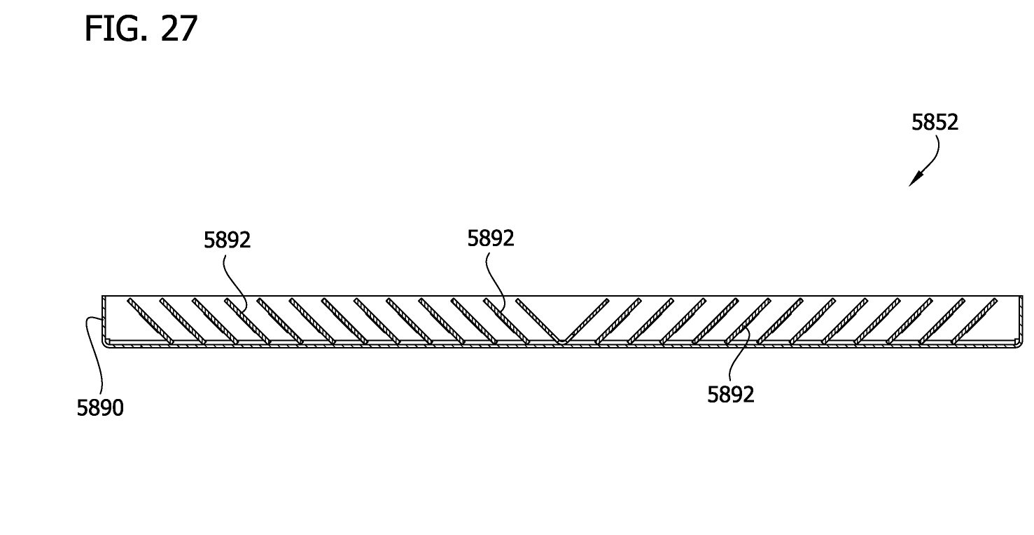

Referring now to FIGS. 26 and 27, the filter 5852 is adapted for obstructing the flow of gas or creating a tortuous flow path through the filter to cause particles (e.g., crumbs and salt) and oil from the food to separate from the gas flow. Desirably, the obstruction of the gas flow prevents the gas flow from re-circulating the particles or oil. The particles and oil may impact the filter 5852 and fall below the filter to a position (e.g., on the catch pans 5856) for collection and removal from the oven 5800. The illustrated filter 5852 includes a filter element support 5890 in the form of a rectangular frame which defines an opening. The filter 5852 includes a plurality of filter elements 5892 connected to the frame and extending across the opening. The filter 5852 may be made of any suitable material, including sheet metal and plastic materials. In the illustrated embodiment, the filter elements 5892 comprise a plurality of generally elongate flat blades having longitudinal axes extending widthwise across the filter opening from the left to the right of the frame 5890. As shown in FIG. 27, the blades 5892 are spaced from one another between the front and back of the frame to permit gas flow between the blades. The blades 5892 are oriented at an angle off vertical to cause the gas to flow transversely or laterally (e.g., forward or rearward) with respect to the filter 5852 as the gas passes through the filter. The blades 5892 on a front portion of the filter 5852 are oriented to direct gas flow generally rearwardly with respect to the filter, and the blades 5892 on a back portion of the filter are oriented to direct gas flow generally forwardly with respect to the filter. Other types of filters, including filters with other types of filter elements, may be used without departing from the scope of the present invention. For example, other suitable types of filters may be used, including catalysts or other devices, for cleaning the gas exhausted from the heating compartments 5886-5888.

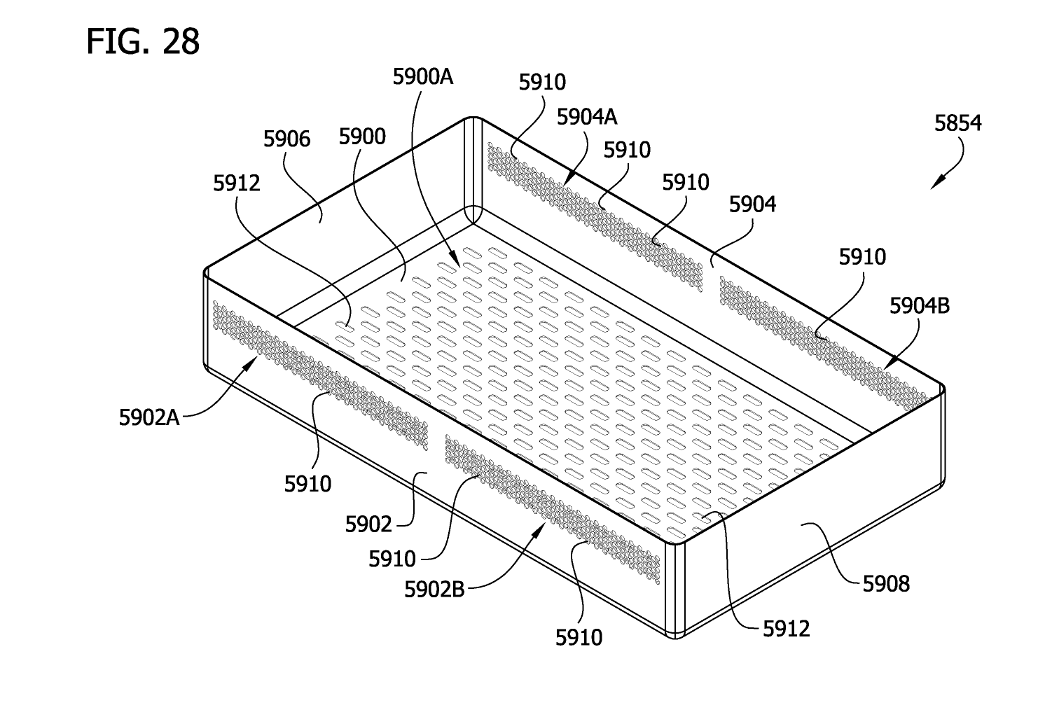

Referring to FIG. 28, the receptacle 5854 comprises a pan-shaped member including a lower wall 5900 and an upstanding peripheral wall including front and back side walls 5902, 5904 and left and right side walls 5906, 5908. The receptacle 5854 defines a cavity for receiving the filter 5852 and the food support 5850.

In the illustrated embodiment, upper portions of the front and back side walls 5902, 5904 of the receptacle 5854 function as baffle members 5902A, 5902B, 5904A, 5904B. As will become apparent, the baffle members 5902A, 5902B, 5904A, 5904B control or guide flow of gas into the heating compartments 5886-5888. Left baffle members 5902A, 5904A of the front and back side walls 5902, 5904 are associated with the left and intermediate heating compartments 5886-5887, and right baffle members 5902B, 5904B of the front and back side walls 5902, 5904 are associated with the right heating compartment 5888. In the illustrated embodiment, each baffle member 5902A, 5902B, 5904A, 5904B comprises a plurality of gas flow openings 5910 arranged in an array including columns and rows of gas flow openings. The gas flow openings 5910 are relatively small generally circular openings. The gas flow openings 5910 are provided at upper ends of the front and back side walls 5860, 5862 of the receptacle 5854, above non-perforated lower ends of the front and back side walls. Gas delivered through the baffle members 5902A, 5902B, 5904A, 5904B passes through the gas flow openings 5876 in the side walls 5860, 5862 of the food support 5850. The configuration of the gas flow openings 5910 (e.g., size, number, shape, spacing, etc.) may be selected to provide desired gas flow into the heating compartments 5886-5888. Although the left and right baffle members 5902A, 5902B, 5904A, 5904B of the front and back side walls 5902, 5904 are shown as having the same configuration, it will be understood that they may be different from each other (e.g., for providing different gas flow volume or direction in different food compartments 5886-5888).

The lower wall 5900 of the receptacle 5854 functions as a baffle member 5900A having a plurality of gas flow openings or perforations 5912 which permit gas and particles to pass therethrough. When assembled, the baffle member 5900A of the lower wall 5900 underlies the food support 5850 and filter 5852. In the illustrated embodiment, the gas flow openings 5912 are generally elongate slot-shaped flow openings arranged in an array including several columns and rows of openings. The baffle member 5900A of the lower wall 5900 may assist the filter 5852 or be used without the filter for separating particles and oil from the gas flow. The baffle member 5900A of the lower wall 5900 assists the filter 5852 in creating a tortuous gas flow path for separating particles and oil from the gas flow. Particles and oil pass through the baffle member 5900A of the lower wall 5900 of the receptacle 5854 for collection on the catch pans 5856. Desirably, the receptacle 5854 is removable for cleaning particles and oil which may collect or accumulate on the receptacle.

The receptacle 5854 may be formed of any suitable material, including sheet metal and plastic materials. Desirably, the receptacle 5854 is formed as a single piece or several pieces connected together. However, the receptacle 5854 may be formed by separate pieces not connected together but mounted with respect to each other to form the receptacle. Receptacles having other configurations may be used without departing from the scope of the present invention. For example, the baffle members 5900, 5902A, 5902B, 5904A, 5904B may have other configurations for imparting desired air flow into the heating compartments 5886-5888 (e.g., in a certain pattern or direction). Moreover, the upper baffle members 5902A, 5902B, 5904A, 5904B of the front and back side walls of the receptacle 5854 may be separately installed, such as gas discharge plates described in other embodiments herein. Moreover, receptacles which are not removable or which include only some parts which are removable may be used without departing from the scope of the present invention. In addition, it will be understood that the receptacle 5854 may be omitted without departing from the scope of the present invention.

As shown in FIG. 24, each catch pan 5856 includes a non-perforated bottom wall 5920 and an upstanding peripheral rim 5922 having a peripheral outwardly extending flange 5924. The catch pans 5856 are configured for catching particles (e.g., salt and food particles) and oil which may fall through the food support 5850, filter 5852, and receptacle 5854. The catch pans 5856 may be removed from the housing 5822 and emptied. Other types of catch pans or other arrangements for collecting and removing the particles and/or oil may be used without departing from the scope of the present invention.

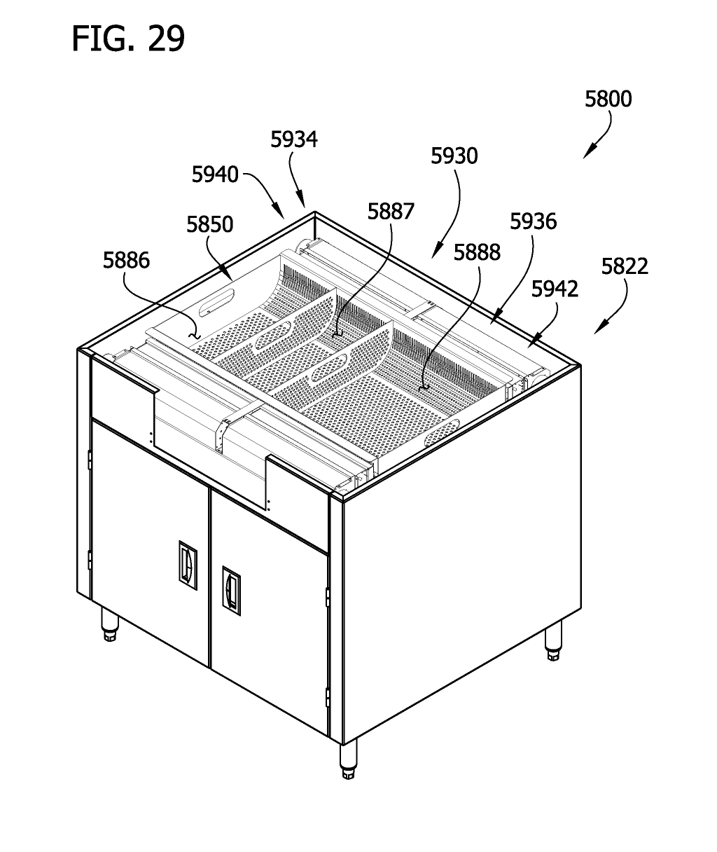

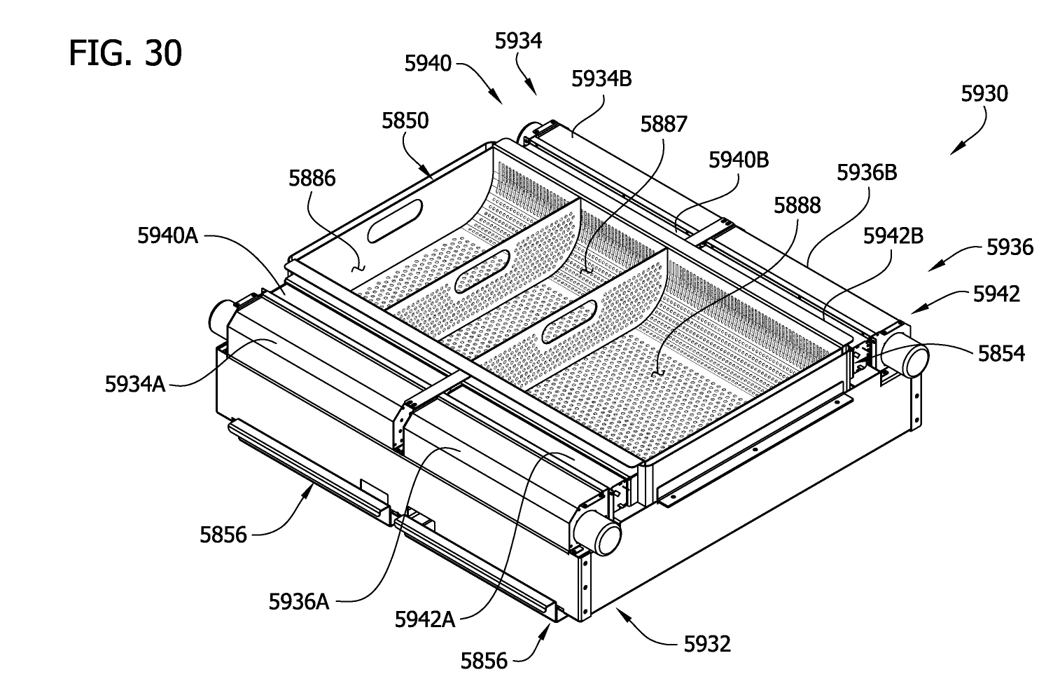

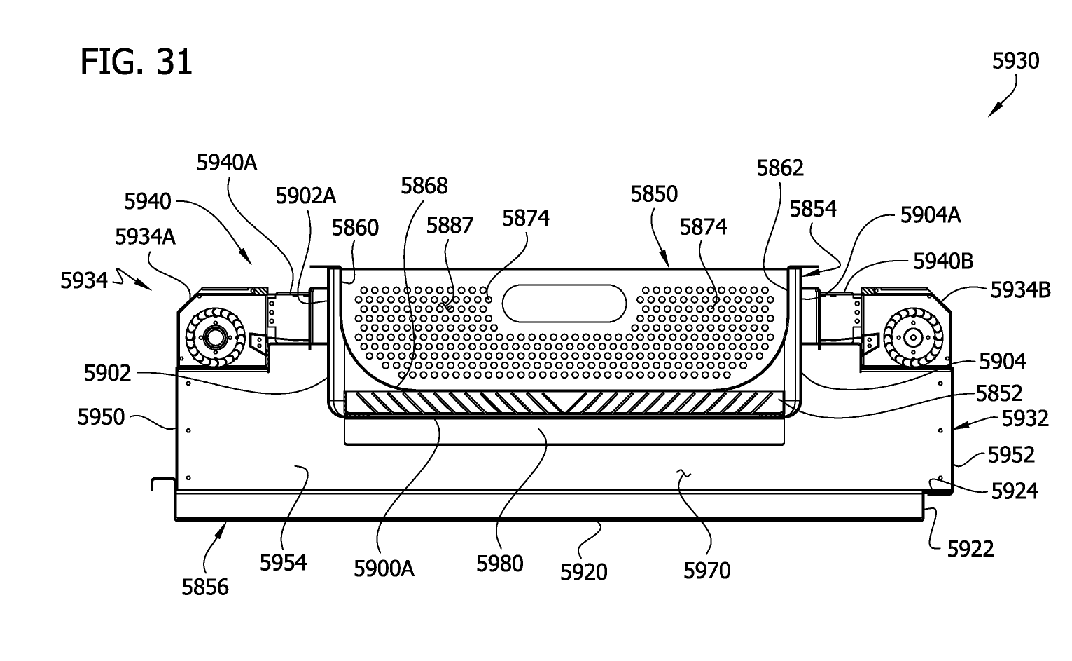

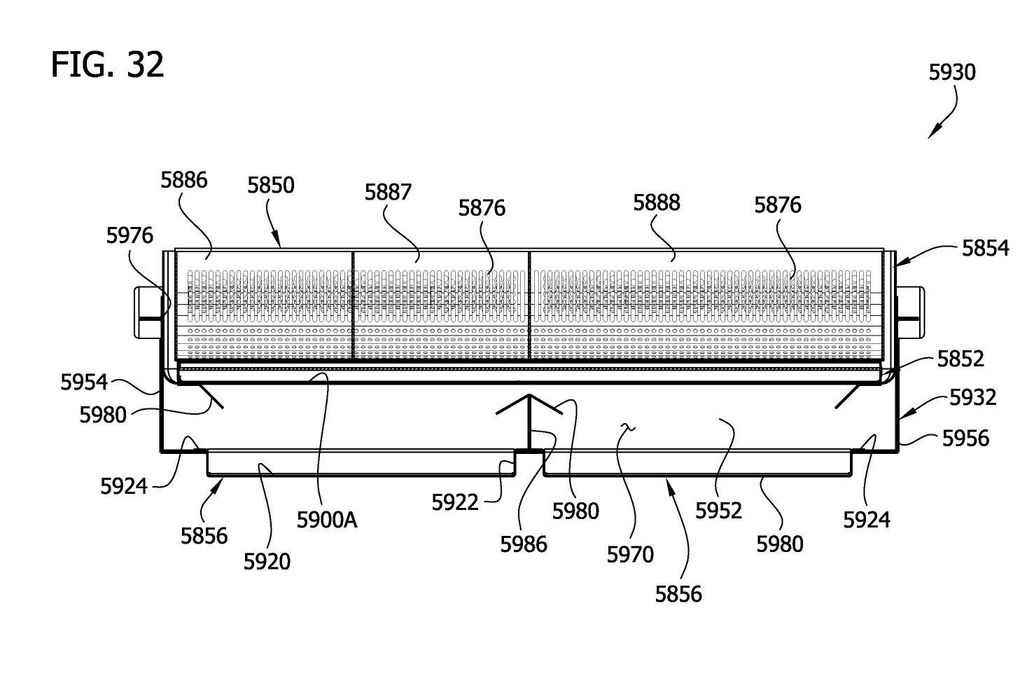

Referring now to FIGS. 29 and 30, a food holding assembly 5930 is shown supported in the upper interior of the housing 5822. In FIG. 29, the upper wall 5824 and control section 5822C of the housing 5822 are removed to expose certain components of the food holding assembly 5930, and FIG. 30 illustrates the food holding assembly by itself. The food holding assembly 5930 includes several components previously described, including the food support 5850, the filter 5852, and the receptacle 5854. In addition, the food holding assembly 5930 includes a frame or plenum housing 5932, first and second blower systems 5934, 5936, and first and second heater systems 5940, 5942. The blower systems 5934, 5936 are provided for blowing gas into the heating compartments 5886-5888, and the heater systems 5940, 5942 heat the gas blown into the heating compartments. The food holding assembly 5930 is shown in widthwise and lengthwise section in FIGS. 31 and 32, respectively.

It will be understood that housing 5822 for the food holding assembly 5930 may have configurations different from the housing 5822 illustrated in FIG. 29 without departing from the scope of the present invention. As described above, the illustrated housing 5822 includes storage space in its interior which is accessible via the doors 5836. Alternatively, a housing for the food holding assembly 5930 may be much smaller and be configured for housing only the food holding assembly or only some parts of the food holding assembly, without departing from the scope of the present invention. For example, the housing 5822 may merely cover the blower and/or heater systems 5940, 5942 to conceal them from view or contact. Moreover, it will be understood that the housing 5822 may be omitted without departing from the scope of the present invention. It will be appreciated that the food holding assembly 5930 as shown in FIG. 30 may be used as a free standing appliance without being positioned in a housing 5822.

The first and second blower systems 5934, 5936 are positioned for blowing gas into respective heating compartments 5886-5888. In the illustrated embodiment, the first blower system 5934 is associated with the left and intermediate heating compartments 5886, 5887, and the second blower system 5936 is associated with the right heating compartment 5888. Each blower system 5934, 5936 includes front and back blowers 5934A, 5934B, 5936A, 5936B. The blowers 5934A, 5934B, 5936A, 5936B may be variable speed tangential blowers. Desirably, the blower systems 5934, 5936 are operable independently such that the gas flow for the left and intermediate heating compartments 5886, 5887 may be different than the gas flow for the right heating compartment 5888.

The first and second heater systems 5940, 5942 each include front and back heaters 5940A, 5940B, 5942A, 5942B associated with respective front and back blowers 5934A, 5934B, 5936A, 5936B of the blower systems 5934, 5936. The heaters 5940A, 5940B, 5942A, 5942B may be electric heaters with open coil heating elements capable of delivering substantial heat quickly to the gas passing by the heating elements. Other types of heaters, including finned heaters, may be used without departing from the scope of the present invention.

Desirably, the by means of a direct connection (e.g., a flange connection) with no intervening ductwork between the respective blowers and heaters. By way of example but not limitation, the blower and heater combination may be of the type commercially available from LTG Incorporated, product designation LTG Tangential Fan TAh. Alternatively, the heaters 5940A, 5940B, 5942A, 5942B may be incorporated as integral parts of the blowers 5934A, 5934B, 5936A, 5936B. Respective blowers and heaters may be referred to as blower/heater units. Although the blower/heater units are illustrated as being positioned in the front and back housing sections 5822A, 5822B, they may be positioned on left and right sides of respective compartments 5886-5888 (in between compartments of a row or to the left and right sides of a single compartment) for delivery of heated gas from the left and right sides of the compartments, without departing from the scope of the present invention.

FIG. 31 illustrates a section of the food holding assembly 5930 taken along the length of the intermediate heating compartment 5887. As shown, the front blower 5934A and front heater 5940A are supported on the frame 5932 to position the blower/heater outlet immediately adjacent to and substantially face-to-face with the respective baffle member 5902A of the front side wall 5902 of the receptacle 5854 and the gas flow openings 5876 of the front side wall 5860 of the food support 5850 for blowing heated gas directly into the front of the intermediate heating compartment 5887. Likewise, the back blower 5934B and back heater 5936B are supported on the frame 5932 to position the blower/heater outlet immediately adjacent to and substantially face-to-face with the respective baffle member 5904A of the back side wall 5904 of the receptacle 5854 and the gas flow openings 5876 of the back side wall 5862 of the food support 5850 for delivering heated gas directly into the back of the intermediate heating compartment 5887. Although only the intermediate heating compartment 5887 is shown in lengthwise section, it will be understood that similar configurations of the blowers 5934A, 5934B, 5936A, 5936B and heaters 5940A, 5940B 5942A, 5942B are provided for the left and right heating compartments 5886, 5888.

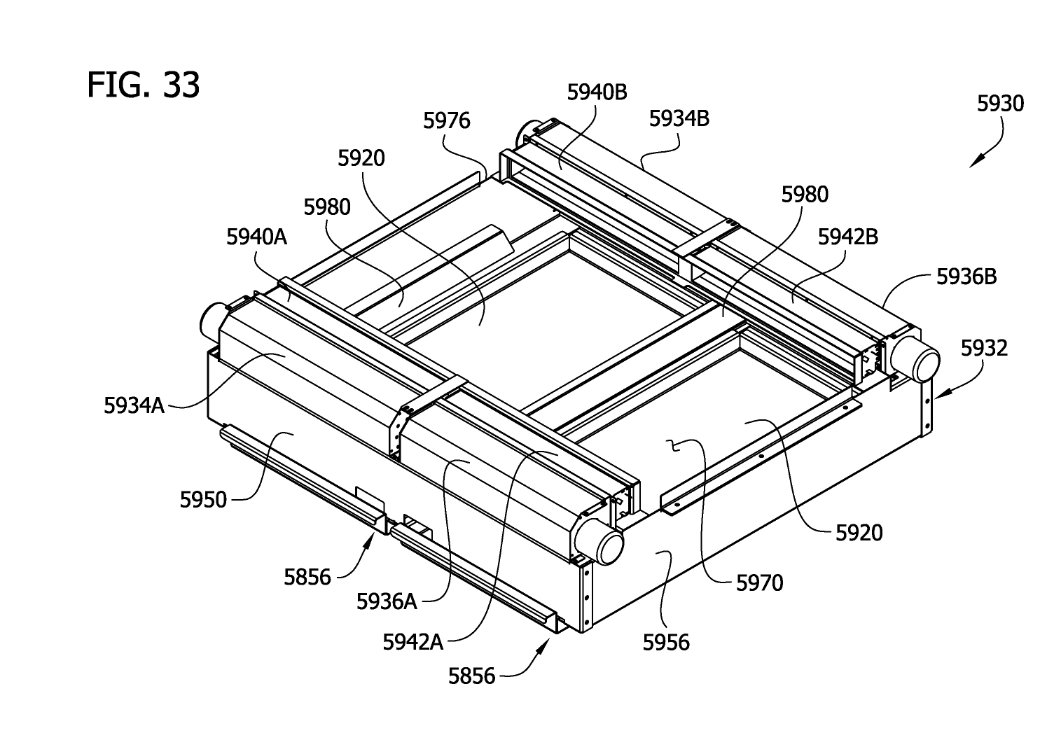

Referring to FIGS. 31-33, the frame 5932 of the food holding assembly 5930 includes front, back, left, and right side walls 5950, 5952, 5954, 5956 which define corresponding boundaries of a gas plenum 5970 of the food holding assembly 5930. Accordingly, the frame 5932 may be referred to as a gas plenum housing. FIG. 33 illustrates the food holding assembly 5930 without the food support 5850, filter 5852, and receptacle 5854 to expose the gas plenum 5970 of the food holding assembly 5930. As shown in FIG. 33, like the main housing 5822, the gas plenum housing 5932 includes an upper opening 5976 for receiving the receptacle 5854, the filter 5852, and the food support 5850. In FIG. 34, the receptacle 5854 and filter 5852 but not the food support 5850 are shown in the upper opening 5976. As shown most clearly in FIGS. 31 and 32, when the receptacle 5854 is received in the upper opening 5976 of the plenum housing 5932, the receptacle defines a central upper boundary of the gas plenum 5970. The receptacle 5854 extends below the upper opening 5976 of the gas plenum housing 5932 for receiving the food support 5850 in a position in which the blower systems 5934, 5936 may deliver gas to the heating compartments 5886-5888 of the food support. As best illustrated in FIG. 33, a lower end of the plenum housing includes openings having peripheral edge margins for serving as slide rails for slidably receiving and supporting the catch pans 5856 below the food support 5850. The catch pans 5856 are removable from the plenum housing 5932 by sliding them out of the front of the plenum housing. The catch pans 5856 substantially define a lower boundary of the gas plenum 5970. As shown in FIGS. 32 and 33, left, right, and intermediate deflectors 5980 are positioned above the edge margins of the catch pans 5856 for guiding falling particles and oil onto the catch pans. The receptacle 5854 is supported in the plenum housing by the left and right deflectors 5980.

As is now apparent, the blower/heater units 5934A, 5934B, 5936A, 5936B, 5940A, 5940B, 5942A, 5942B draw and heat gas from the gas plenum 5970 and deliver it to the heating compartments 5886-5888 without substantial intervening ductwork (and preferably no intervening ductwork) between the blower/heater units and the food support 5850. The gas flow openings 5910 in respective baffle members 5902A, 5902B, 5904A, 5904B of the receptacle 5854 direct the heated gas into the left, intermediate, and right heating compartments (lanes) 5886-5888 for heating food held on respective food support surfaces in the compartments. The gas may be directed in a downwardly angled direction toward the food in respective compartments 5886-5888. The flow of heated gas across the food and around the food helps to hold the heat in food placed in the compartments 5886-5888, thereby extending the holding time for the food. Gas is exhausted from the heating compartments 5886-5888 by negative pressure downward through the food support 5850, filter 5852, and receptacle 5854 into the plenum 5970 for re-circulation by the blower/heater units.

The independent control of the first and second blower and heater systems 5934, 5936, 5940, 5942 may be enhanced by the gas plenum 5970 being partitioned into separate gas plenum sections. As shown in FIG. 32, an upstanding partition 5986 which supports the intermediate deflector 5980 extends within the plenum from adjacent the front side wall 5950 of the plenum housing 5932 to adjacent the back side wall 5952 of the plenum housing. The partition 5986 separates a left side of the gas plenum 5970 from a right side of the plenum, creating the partitioned separate plenum sections. Other configurations may be used without departing from the scope of the present invention. For example, in other embodiments, each blower system 5934, 5936 may comprise a single blower in combination with ductwork for routing gas from the blower to the gas flow openings 5876 in the front and back side walls 5860, 5862 of the heating compartments 5886-5888. Similarly, each heater system 5940, 5942 may comprise a single heater or two or more heaters for heating the gas before it exits the gas flow openings 5876 in the side walls 5860, 5862.

Optionally, as described in prior embodiments, one or more motion sensors may be provided for detecting the motion of a hand, arm, or scoop within the heating compartments 5886-5888. A control in the control housing 5822C may be responsive to the sensors detecting any such motion for shutting off the respective blower system(s) 5934, 5936.

In operation, hot food from a fryer, for example, is placed on the food support 5850 in the left, intermediate, and/or right heating compartment(s) 5886-5888. For example, sweet potato fries and onion rings may be positioned in the left and intermediate heating compartments 5886, 5887, respectively. Regular potato fries may be positioned in the right heating compartment 5888. The food is heated and held in the compartments 5886-5888 under desired gas flow and temperature conditions by the delivery of heated gas to the heating compartments. The gas flow and/or temperature conditions in the left and intermediate heating compartments 5886, 5887 can be different from the gas flow and/or temperature conditions in the right heating compartment 5888 because the blower and heater systems 5934, 5936, 5940, 5942 are independently operable. Moreover, the gas flow openings 5910 of the receptacle baffle members 5902A, 5902B, 5904A, 5904B corresponding to different heating compartments 5886-5888 may have different configurations for causing different gas flow into the respective heating compartments. Gas exits the heating compartments 5886-5888 through the gas flow openings 5874 in the bottom wall 5868 of the food support 5850 and passes through the filter 5852 and receptacle 5854 into the gas plenum 5970 for recirculation through the blower and heater systems 5934, 5936, 5940, 5942. Desirably, the filter 5852 separates particles and oil from the gas flow and causes them to fall to the catch pans 5856 for collection and removal. When it is desired to serve food from one of the heating compartments 5886-5888, it is removed from the heating compartment using a scooping motion, as described above. The supply of food in the heating compartments 5886-5888 can be replenished as necessary.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. An oven for heating food, comprising
a first heating compartment having first and second opposing side walls, a first food support surface for supporting food to be heated, and an open top in open communication with a surrounding environment outside the oven,
first gas flow openings in the first and second opposing side walls,
a first blower system for blowing gas through the first gas flow openings into the first heating compartment for flow onto the food supported by the first food support surface, and
a first heater system for heating gas blowing into the heating compartment through the first gas flow openings.

2. The oven set forth in claim 1, wherein the first and second opposing side walls are opposing front and back side walls.

3. The oven set forth in claim 1, wherein the first and second opposing side walls are opposing left and right side walls.

4. The oven set forth in claim 3, wherein the first heating compartment has an open front in open communication with the surrounding environment outside the oven.

5. The oven set forth in claim 1, wherein the first blower system comprises a first blower positioned for blowing gas through the first gas flow openings in the first side wall and a second blower positioned for blowing gas through the first gas flow openings in the second side wall, and wherein the first heater system comprises a first heater associated with the first blower for heating gas blown through the first gas flow openings in the first side wall and a second heater associated with the second blower for heating gas blown through the first gas flow openings in the second side wall.

6. The oven set forth in claim 1, further comprising a second heating compartment, said second heating compartment having opposing side walls, second gas flow openings in the opposing side walls for flow of heated gas through the second gas flow openings into the second heating compartment, and a second food support surface for supporting food to be heated by gas flowing through the second gas flow openings.

7. The oven set forth in claim 6, wherein the second heating compartment is below the first heating compartment.

8. The oven set forth in claim 7, wherein the second heating compartment has an open front in open communication with said surrounding environment outside the oven.

9. The oven set forth in claim 6, wherein the second heating compartment is beside the first heating compartment.

10. The oven set forth in claim 9, wherein the second heating compartment has an open top in open communication with said surrounding environment outside the oven.

11. The oven set forth in claim 6, further comprising a second blower system associated with the second heating compartment adapted for blowing gas through the second gas flow openings in the side walls into the second heating compartment, the second blower system being operable independently of the first blower system.

12. The oven as set forth in claim 6, further comprising a second heater system associated with the second heating compartment adapted for heating the gas blown into the second heating compartment, the second heater system being operable independently of the first heater system.

13. The oven set forth in claim 1,
wherein the first heating compartment, first food support surface, first gas flow openings, first blower system, and first heater system are incorporated in a first oven module,
wherein the oven further comprises a second oven module comprising a second module heating compartment having an open top and an open front, a second module food support surface in the second module heating compartment, second module gas flow openings in at least one side wall of the second module heating compartment, a second module blower system for blowing gas through the second module gas flow openings, and a second module heater system for heating gas blowing into the second module heating compartment through the second module gas flow openings, and
wherein the first oven module is stackable on the second oven module oven such that a bottom wall of the first oven module closes the open top of the second module heating compartment.

14. The oven set forth in claim 13, wherein the first and second oven modules are operable independently of one another.

15. The oven set forth in claim 1, further comprising a motion sensor for detecting the motion of a hand or arm within the first heating compartment, and a control responsive to the sensor detecting said motion for shutting off the first blower system.

16. The oven set forth in claim 1, wherein the first side wall comprises a first air discharge plate having said first gas flow openings therein of a first configuration, said first air discharge plate being interchangeable with a second discharge plate having gas flow openings therein of a second configuration different from said first configuration.

17. The oven set forth in claim 16, wherein the first air discharge plate is configured for directing gas blown through the first gas flow openings at a downwardly inclined angle in the first heating compartment toward the first food support surface.

18. The oven set forth in claim 1,
further comprising a housing comprising a first side housing section extending alongside the first side wall of the first heating compartment, and a second side housing section extending alongside the second side wall of the first heating compartment, and
wherein a first blower of the first blower system and a first heater of the first heater system are located in said first side housing section.

19. The oven set forth in claim 18, wherein a second blower of the first blower system and a second heater of the first heater system are located in said second side housing section.

20. The oven set forth in claim 19, wherein the first and second side housing sections are front and back side housing sections.

21. The oven set forth in claim 19, wherein the housing further comprises a back housing section, the first side housing section being a left side housing section extending forward from the back housing section, and the second side housing section being a right side housing section extending forward from the back housing section, the first heating compartment having an open front.

22. An oven for heating food, comprising
a first heating compartment for heating food placed in the compartment, the heating compartment having at least one side wall, a bottom wall, and an open top in open communication with a surrounding environment outside the oven,
first gas flow openings in the at least one side wall,
a first blower system for blowing gas through said gas flow openings in the at least one side wall into the first heating compartment,
a first heater system for heating gas blowing into the first heating compartment through said gas flow openings in the at least one side wall,
first gas flow openings in the bottom wall of the heating compartment, and
wherein gas blows into the first heating compartment via said first gas flow openings in the at least one side wall and gas exhausts from the first heating compartment via said first gas flow openings in the bottom wall of the first heating compartment.

23. The oven set forth in claim 22, wherein the bottom wall of the first heating compartment comprises a food support surface for supporting food to be heated by the gas blown into the first heating compartment.

24. The oven set forth in claim 23, wherein the food support surface is curved to facilitate removal of food on the first food support surface using a scooping motion.

25. The oven set forth in claim 22, wherein said at least one side wall comprises first and second side walls each including first gas flow openings, the first and second side walls opposing each other, wherein gas blows into the first heating compartment via said first gas flow openings in the first and second opposing side walls and exhausts from the first heating compartment via said first gas flow openings in the bottom wall of the first heating compartment.

26. The oven set forth in claim 25, wherein said opposing side walls are opposing front and back side walls.

27. The oven set forth in claim 22, further comprising a second heating compartment beside the first heating compartment, the second heating compartment comprising at least one side wall having second gas flow openings, a bottom wall comprising second gas flow openings, and an open top in open communication with the surrounding environment outside the oven, wherein gas blows into the second heating compartment via said second gas flow openings in the at least one side wall and gas exhausts from the heating compartment via said second gas flow openings in the bottom wall of the second heating compartment.

28. The oven set forth in claim 27, wherein the first blower and heater systems are associated with at least the first heating compartment, the oven further comprising second blower and heater systems associated with at least the second heating compartment, the second blower and heater systems being operable independently of the first blower and heater systems.

29. The oven set forth in claim 22, further comprising a housing including a gas plenum below the first heating compartment into which gas from the first heating compartment exhausts through the first gas flow openings in the bottom wall of the first heating compartment.

30. The oven set forth in claim 29, wherein the bottom wall of the first heating compartment comprises a food support surface of a food support for supporting food to be heated by the gas blown into the first heating compartment, and the oven further comprises a receptacle in the housing configured for removably receiving the food support.

31. The oven set forth in claim 30, wherein the receptacle defines at least a portion of an upper boundary of the gas plenum.

32. The oven set forth in claim 30, wherein the receptacle comprises a pan-shaped member which is removable from the housing via an opening in the housing for cleaning and replacement back in the housing.

33. The oven set forth in claim 29, further comprising a filter below the first heating compartment through which gas from the first heating compartment flows into the gas plenum for cleaning the air exhausted from the first heating compartment.

34. An oven for heating food, comprising
a first heating compartment having at least a first side wall, and a food support surface for supporting food to be heated,
first gas flow openings in the first side wall,
a first blower system for blowing gas through the first gas flow openings into the first heating compartment for flow onto the food supported by the first food support surface,
a first heater system for heating gas blowing into the heating compartment through the first gas flow openings, and
a motion sensor for detecting motion within the first heating compartment, and a control responsive to the sensor detecting said motion for shutting off the first blower system.

35. The oven of claim 34 wherein the first heating compartment has an open top in open communication with a surrounding environment outside the oven, and the motion sensor is positioned adjacent the open top.

36. The oven of claim 24 wherein the first heating compartment has an open front in open communication with a surrounding environment outside the oven, and the motion sensor is positioned adjacent the open front.

37. An oven for heating food, comprising
a plurality of oven modules,
each oven module comprising a heating compartment having first and second opposing side walls, a food support surface for supporting food to be heated, an open front in open communication with a surrounding environment outside the oven, and an open top in open communication with said surrounding environment outside the oven, and each oven module comprising a housing comprising a back housing section, a first side housing section extending forward from the back housing section alongside the first side wall of the heating compartment, and a second side housing section extending forward from the back housing section alongside the second side wall of the first heating compartment, and,
gas flow openings in the first side wall,
a blower for blowing gas through the gas flow openings into the heating compartment for flow onto the food supported by the food support surface,
a heater for heating gas blowing into the heating compartment through the gas flow openings,
wherein the oven modules are stackable one on top of the other such that a bottom wall of an upper oven module closes the open top of a lower oven module below the upper oven module.

38. The oven set forth in claim 37, wherein the food support surface of the lower module is part of a tray which is removable from the open front of the lower module.

39. The oven set forth in claim 37, wherein the food support surface of the upper module is removable to convert the upper module into a module suitable for use as a lower module.

40. The oven set forth in claim 37, wherein said blower and heater are located in said first side housing section.

41. The oven set forth in claim 40, wherein each oven module further comprises a second blower and second heater located in said second side housing section for blowing heated gas through gas flow openings in the second side wall of the heating compartment.

42. The oven set forth in claim 37, wherein the heater and blower combine to form a blower/heater unit which is directly connected to a respective side wall of the heating compartment without intervening ductwork between the blower/heater unit and the side wall.
